(19) United States
(12) Patent Application Publication
(10) Pub. No.: US 2025/0235891 A1
(43) Pub. Date: Jul. 24, 2025

(54) ASSEMBLED MXENE NANOMATERIAL COATING BY SOLUTE-ASSISTED ASSEMBLY AND METHOD OF USING THE SAME

(71) Applicants: Villanova University, Villanova, PA (US); Drexel University, Philadelphia, PA (US)

(72) Inventors: Bo Li, Malvern, PA (US); Liang Zhao, Bryn Mawr, PA (US); Yury Gogotsi, Ivyland, PA (US); Lingyi Bi, Philadelphia, PA (US)

(21) Appl. No.: 19/024,943

(22) Filed: Jan. 16, 2025

Related U.S. Application Data
(60) Provisional application No. 63/623,093, filed on Jan. 19, 2024.

(51) Int. Cl. B05D 1/18; B05D 5/12; B82Y 30/00; H05B 3/14; H05B 3/16

(52) U.S. Cl. CPC B05D 1/18; B05D 5/12; B82Y 30/00; H05B 3/141; H05B 3/16; B05D 2201/02; B05D 2301/00; B05D 2601/20; H05B 2203/017; H05B 2203/036

(57) ABSTRACT

An article, a method of making the same, and a method of using the same are provided. Such an article includes at least one coated layer, which includes a substrate and a coating disposed on the substrate. The coating includes a layered nanomaterial and a solute embedded and distributed in the layered nanomaterial. The solute comprises at least one salt soluble in a solvent. The substrate comprises a polymer, for example, a high-performance polymer such as polyether ether ketone and poly(para-phenylene terephthalamide). The article is used for thermal management applications, for example, as protective garment.

### PRIORITY CLAIM AND CROSS-REFERENCE

This application claims the benefit of U.S. Provisional Application No. 63/623,093, filed Jan. 19, 2024, which application is expressly incorporated by reference herein in its entirety.

### STATEMENT REGARDING FEDERALLY SPONSORED RESEARCH

At least a part of the research described in the present disclosure is federally sponsored under Grant/Contract Nos. 2003077, 2221102, and 2018852 from the National Science Foundation (NSF). The government has certain rights in the invention.

### FIELD OF THE INVENTION

The disclosure relates to nanomaterials and coatings generally. More particularly, the disclosed subject matter relates to a nanomaterial coating on a substrate, and the resulting coated products, and the methods of using the same.

### BACKGROUND

Functional coating and electronics require assembling nano/microparticles on target substrates such as polymers, ceramics, and metals. The market of functional coatings and electronics has a great potential, but techniques for high rate, cost-efficient and environment-friendly manufacturing of functional coatings and electronics from nano/microparticles are limited. The processing of nano/microparticles is very expensive and time-consuming.

The existing dip coating technologies are based on an evaporation driven assembly process with a very low coating speed. The deposition happens at the solid-liquid-vapor contact line. To obtain a stable deposition, the receding of the solid-liquid-vapor contact line should be stable, which requires a delicate balance between substrate withdrawal and solution evaporation. Therefore, the withdrawal speed of the dip coating is difficult to increase. Also, a stable and well-dispersed solution is necessary for the preparation of a uniform film. Therefore, organic solvent or water with surfactants as the solvent has been widely adopted.

Organic solvents or water with surfactants based aqueous solution was used for nano/microparticle dispersion. Usually, post-treatment will be necessary to remove the organic solvents and surfactants.

### SUMMARY OF THE INVENTION

The present disclosure provides an article comprising a nanomaterial coating on a substrate, a method of making the same, and a method of using the same. The coating is made through solute-assisted assembly. The nanomaterial coating includes a layered (2D) nanomaterial such as MXene (e.g., Ti₃C₂Tₓ), which is made of a-few-atoms-thick layers of carbide, nitride, or carbonitride of transition metal.

In accordance with some embodiments, an article comprises at least one coated layer, which comprises a substrate and a coating disposed on the substrate. The coating comprises a layered nanomaterial and a solute embedded and uniformly distributed in the layered nanomaterial. The solute comprises at least one salt soluble in a solvent, and the substrate comprises a polymer.

The nanomaterial has at least one dimension in a range of from about 1 nm to about 1,000 nm. The layered nanomaterial has a thickness in a range of from about 1 nm to about 1,000 nm, for example, in a range of from about 4 nm to about 1,000 nm.

The layered nanomaterial comprises nanosheets of MXene. MXene is a layered nitride, carbide, or carbonitrides of at least one transition metal (M) having a formula of Mₙ₊₁XₙTₓ.×is nitrogen or carbon, n is an integer representing the number of layers of nitrogen or carbon, n+1 is the number of layers of the at least one transition metal, T is a functional group, and x is in a range of from 0 to 2. In some embodiments, n is in the range of from 1 to 3. Examples of T include, but are not limited to F, Cl, O, OH, and a combination thereof.

In some embodiments, the MXene has a formula of Ti₃C₂Tₓ.

In some embodiments, the 2D nanomaterial (nanosheet) used such as MXene has a single-layered structure or have several layers, for example, any suitable number of layers in a range of from 2 to 10. In some embodiments, the MXene nanosheets used is negatively charged during the coating process so as to prevent aggregation of the nanosheets.

In the coating, the layered nanomaterial is oriented in a plane substantially parallel to a surface of the substrate.

The nature of the nanomaterials and the substrate can be similar or different. In some embodiments, the nature of the nanomaterials and the substrate are opposite. For example, the nanomaterial is hydrophilic while the substrate is hydrophobic, or the nanomaterial is hydrophobic while the substrate is hydrophilic. In some embodiments, the layered nanomaterial such as MXene is hydrophilic while the substrate is hydrophobic.

The substrate can be any suitable substrate of any chemical composition and of any shape. In some embodiments, the polymer in the substrate is in a form of a film, or a fabric comprising fibers.

Examples of a suitable polymer include, but are not limited to polyether ether ketone (PEEK), polyvinylidene fluoride (PVDF), polytetrafluoroethylene (PTFE), polyethene (PE), polypropylene (PP), polyethylene terephthalate (PET), polybenzimidazole (PBI), polycarbonate (PC), polyether sulfone (PES), polyoxymethylene (POM), polyethylenimine (PEI), acrylonitrile butadiene styrene (ABS), poly(phthalaldehyde) (PPA), polyurethane (PU), a polyamide, and any combination thereof.

In some embodiments, the polymer is a high-performance polymer such as PEEK or poly(para-phenylene terephthalamide). In some embodiments, the substrate comprises fibers or fabrics, which may be made of a high-performance polymer such as PEEK and poly(para-phenylene terephthalamide).

The at least one salt comprises a metal cation and an anion. For example, examples of a suitable metal ion include, but are not limited to Lit, Na⁺, K⁺, Rb⁺, Cs⁺, Mg²⁺, Ca²⁺, Sr²⁺, Ba²⁺, Al³⁺, Sc³⁰, Cr³⁺, V³⁺, Ti⁴⁺, Mn²⁺, Fe³⁺, Co²⁺, Ni²⁺, Cu²⁺, Zn²⁺, Ga³⁺, Ge⁴⁺, Y³⁺, Zr⁴⁺, Nb⁵⁺, Mo³⁺, Ru³⁺, Re³⁺, Os³⁺, Au³⁺, Bi³⁺, Ir³⁺, Pt⁴⁺, La³⁺, Hf⁴⁺, W⁶⁺, Rh³⁺, Pd²⁺, Cd²⁺, In³⁺, Sn⁴⁺, Sb³⁺, Ag⁺, and a combination thereof. The anion may be F⁻, Cl⁻, Br⁻, I⁻, CO₃²⁻, HCO₃, NO₃⁻, SO₄²⁻, or a combination thereof. The at least one salt is water-soluble.

In some embodiments, the solute comprises one or more salts.

In some embodiments, the layered nanomaterials have a size of spacing, which is controlled by species of the solute such as salt.

In some embodiments, the coating may have a thickness in a range of from about 1 nanometer to about 1,000 nm, for example, from 4 nm to 1,000 nm, from 10 nm to 1,000 nm, from 10 nm to 900 nm, from 10 nm to 800 nm, or any other suitable ranges. In some embodiments, the nanomaterials are chemically bonded with each other in the coating.

The coating is electrically and/or thermally conductive, and the article is configured to be used for thermal management. The electric conductivity and thermal conductivity of the coating can be adjusted based on the applications.

In some embodiments, the article further comprises at least two electrodes connected with the coating and configured to provide Joule heating.

In some embodiments, the at least one coated layer in the article comprises a first coated layer and a second coated layer the same as the first coated layer. The article further comprises a separation layer disposed between the first coated layer and the second coated layer.

In some embodiments, the article is configured to be wearable and protective and may provide thermal management functions. For example, the article is a protective garment or gear.

In another aspect, the present disclosure provides a method of making the article as described herein. The assembly of the nanomaterial may be assisted in an acoustic field under sonication, or a shear field induced by dip coating, and a shear field induced by mechanical stirring. For example, the nanomaterial may be dispersed, pre-treated, and/or exfoliated after sonication is applied. The substrate is contacted with the mixture through an acoustic agitated process, a dip-coating process, a roll-to-roll process, a mechanical stirring process, or a combination thereof. For example, a dip coating process or a roll-to-roll process is used in some embodiments.

In some embodiments, such a method comprises making the at least one coated layer through a solute-assisted assembly method as described herein. The solute-assisted assembly method comprises steps of providing a mixture comprising the solvent, the solute comprising at least one salt, and the layered nanomaterial, applying sonication to the mixture, and contacting the substrate with the mixture. In some embodiments, the layered nanomaterial comprises MXene. In some embodiments, the solvent is water or comprises water and another solvent. The mixture contains no surfactant. The substrate comprises a polymer.

In another aspect, the present disclosure provides a method of using the article as described herein. Such a method comprises providing at least one thermal management function through the at least one coated layer. In some embodiments, the article is a protective garment or gear, and the at least one thermal management function comprises thermal camouflage, Joule heating, or both.

The present disclosure provides a universal assembly method to coat a nanomaterial such as a 2D material (e.g., MXene) on polymer substrates. The method and the resulting coating product can be also applicable to this large family of 2D materials with unique properties, such as graphene or graphene oxide.

The resulting article product comprising the assembled nanomaterial coating and the substrate, such as a polymer substrate, can be utilized to make flexible electronics, functional textiles, thermal management materials, and any other materials of suitable applications. It can be also used as electrically conductive coating.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 illustrates an exemplary method for forming a nanomaterial coating comprising MXene nanosheets through a solute (e.g., salt) assisted assembly process in accordance with some embodiments.

FIGS. 2A-2B show SEM images of fibers of poly-paraphenylene terephthalamide (under Trademark KEVLAR® initially and generally known as Kevlar fibers) (FIG. 2A) and the fibers coated with one exemplary MXene, Ti₃C₂Tₓ, assembled assisted by NaCl as an exemplary salt (FIG. 2B) in accordance with some embodiments (bar=10 microns).

FIG. 2C shows the diameters of the fibers of FIGS. 2A-2B before and after coated with Na—Ti₃C₂Tₓ.

FIGS. 3A-3C show the results of contact angle measurements of pure water and NaCl solution on MXene and different polymer substrates: (A). Pristine Ti₃C₂Tₓ film obtained by vacuum filtration and on Na—Ti₃C₂Tₓ@PDMS obtained by SAA, (B). Pristine PDMS film, and (C). Pristine PTFE film.

FIGS. 4-5 show the thickness and sheet resistance of MXene coatings assembled on PDMS using different exemplary salts.

FIG. 6 is a schematic illustration of thermal camouflage process using Na—Ti₃C₂Tₓ coatings on high-performance polymers.

FIG. 7 shows evolution of reduction temperature (Treduced) for Na—Ti₃C₂Tₓ on.

PEEK and Na—Ti₃C₂Tₓ on Kevlar within 50 heating cycles.

FIG. 8 shows evolutions of reduction temperature (Treduced) for Na—Ti₃C₂Tₓ on PEEK and Na—Ti₃C₂Tₓ on Kevlar during 48 hours at radiation temperatures (Tradiation) of 300° C. and 400° C., respectively.

FIG. 9 shows reduction temperature (Treduced) evolution of Na—Ti₃C₂Tr on PEEK at 300° C. and Na—Ti₃C₂Tₓ on Kevlar at 400° C. for 120 s.

FIG. 10 shows a schematic illustration of Joule heating using Ti₃C₂Tₓ coating on a high-performance polymer.

FIG. 11 shows voltage-dependent Joule heating performance of Na—Ti₃C₂Tₓ on Kevlar.

FIG. 12 shows long-term Joule heating performance of Na—Ti₃C₂Tr on Kevlar under 4 V.

FIG. 13 shows evolution of reduction temperature at a radiation temperature Tradiation of 400° C. and sheet resistance of Na—Ti₃C₂Tₓ on Kevlar during 2,000 bending cycles.

FIG. 14 shows evolution of sheet resistance for Na—Ti₃C₂Tₓ on PEEK and Na-Ti₃C₂Tr on Kevlar after washing with DI water, IPA solution, and Synthrapol (10% in volume) solution under 1000 rpm stirring.

FIGS. 15A-15B illustrate two exemplary structures for an article such as a protective garment or gear in accordance with some embodiments.

FIG. 15A is a sectional view illustrating an exemplary product comprising a tri-layer H-S-R structure comprising: a Heating layer (Na—Ti₃C₂Tₓ on Kevlar), a Separation layer (pure Kevlar), and a Reflection layer (Na—Ti₃C₂Tₓ on Kevlar).

FIG. 15B is a sectional view illustrating an exemplary product comprising a tri-layer H-S-S structure comprising: a Heating layer (Na—Ti₃C₂Tₓ on Kevlar) and two Separation layers (Kevlar).

FIG. 16 shows the Joule heating temperatures of H-S-R protection gear in contact with dry ice (−78.5° C.). For comparison, the reference sample is H-S-S in which the reflection layer is substituted by a separation layer.

FIG. 17 illustrates an exemplary structure for an article such as a protective garment or gear in accordance with some embodiments.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. Thus, for example, a reference to “a nano structure” is a reference to one or more of such structures and equivalents thereof known to those skilled in the art, and so forth. When values are expressed as approximations, by use of the antecedent “about,” it will be understood that the particular value forms another embodiment. As used herein, “about X” (where X is a numerical value) preferably refers to +10% of the recited value, inclusive. For example, the phrase “about 8” preferably refers to a value of 7.2 to 8.8, inclusive; as another example, the phrase “about 8%” preferably (but not always) refers to a value of 7.2% to 8.8%, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The term “substantially parallel to” used herein is understood to be parallel with a possible variation by an angle in a range of from 0 to 10 degree.

The terms “hydrophobic” and “hydrophilic” used herein are understood to have the same meaning in the chemical and material science. In some embodiments, a hydrophobic material or substrate is understood to have a contact angle of deionized water drop on such material or substrate in a range of from 80 to 180 degree (e.g., 90-150, 100-180 degree). In some embodiments, a hydrophilic material or substrate is understood to have a contact angle of deionized water drop on such material or substrate in a range of from 0 to 80 degree (e.g., 0-30, 20-80 degree), without including 80 degree.

The term “nanomaterial” as used herein is understood to encompass any material having a size of at least one dimension (such as diameter for spherical or near-spherical particles) in nanometer-sized range, for example, from 1 nm to 1,000 nm, from 10 nm to 1,000 nm, or from 50 nm to 1,000 nm. Nanomaterials include 0D nanomaterial such as quantum dots, 1D nanomaterial such as single-wall carbon nanotubes (SWNT), 2D nanomaterials such as graphene, h-BN and MoS2, and 3D nanomaterials such as carbon black, metal oxide, and polymer nanoparticles. The term “three-dimensional (3D) nanomaterial” is used to distinguish from 1D and 2D nanomaterials. The size of nanomaterials is determined by known methods. For example, a standard and accurate method is transmission electron microscopy (TEM).

The terms “2D nanomaterial” and “layered nanomaterial” used herein are understood to encompass nanomaterials having planar or layered structure such as nanosheets and nanoflake.

The term “nanoparticle” as used herein is understood to encompass a nanomaterial having a three-dimensional (3D) shape and having a dimension in a nanometer-sized range, for example, from 10 nm to 1,000 nm, or from 50 nm to 1,000 nm. Examples of such a 3D shape include, but are not limited to a spherical or near-spherical shape, a cube or cuboid, or any other regular shape. Most of the particles have a spherical or near-spherical shape, and such a dimension is the particle diameter.

The term “MXenes” in material science refers to a class of two-dimensional inorganic compounds. MXene is a compound composed of layered nitrides, carbides, or carbonitrides of transition metals. In some embodiments, MXene is composed of a-few-atoms-thick layers of carbide, nitride, or carbonitride of transition metal. A single layer of MXene may have a thickness as thin as 1-2 nanometers. MXenes have a general formula of Mₙ₊₁XₙTₓ. In a 2D nanomaterial (e.g., nanosheets) of Mxene, n+1 (n=1-3) layers of transition metals (M) are interleaved with n layers of carbon or nitrogen (X). Tₓ represents possibly a small number of functional groups (e.g.,—F, Cl,—O, OH) attached on the surface of MXene during its synthesis process, where x is in a range of from 0 to 2. For example, titanium carbide Ti₃C₂Tₓ is one of the exemplary MXenes used in the present disclosure. Multilayer Ti₃C₂Tₓ Mxene nanoflakes are available commercially, for example, from American Elements in Los Angeles, California. The MXene nanosheets used in the present disclosure were from Drexel University.

Conventional coating mechanisms have multiple limitations. To enable high-quality, uniform coatings, both methods require fine control over the molecular interactions among the solvent, nanomaterial, and the substrate (e.g., textiles). More specifically, conventional assembly requirements include: (1) good wetting of the substrate, because nanomaterials dissolved or suspended in the solvent can only deposit at the substrate locations wetted by the solvent, (2) good dispersion of nanomaterials in the solvent, and (3) strong nanomaterial-substrate interactions to enable strong and durable binding. To promote the high-efficiency, scalable, and eco-friendly manufacturing of coatings, water will be used as the solvent, which however greatly limits the choice of nanomaterials and polymers. Taking nanomaterial-on-polymer substrate assembly systems as an example, most of the successful systems from the literature and practice are hydrophilic nanomaterials on hydrophilic substrates which is consistent with the conventional assembly requirements mentioned above.

However, such requirements create challenges to achieve the assembly of a large collection of substrates and functional nanomaterials systems. These challenging systems include hydrophobic nanomaterials on hydrophilic substrate, hydrophilic nanomaterials on hydrophobic substrate, and systems showing weak interactions between substrate and nanomaterials.

To enable assembly for these challenging nanomaterial-polymer systems, traditionally, three types of surface treatment strategies are applied to the nanomaterials and/or polymers to enhance the nanomaterial-polymer-water interactions: 1) surface activation such as plasma treatment, and acid/base treatment, 2) adhesive polymer coating (e.g., polydopamine), and 3) surfactant grafting (e.g., polyelectrolyte and protein). The drawbacks are significant. With surface activation strategies (e.g., plasma treatment), structural integrity of the polymers and nanomaterials can be damaged leading to compromised mechanical, electrical, thermal, and other physical properties. In addition, the polymer surface is not chemically uniform because of the complicated chemical configurations and conformations of polymer chains, making it hard to guarantee a uniform chemical functionalization through these surface activation methods. For adhesive polymer coating and surfactant coating strategies, the added polymers or surfactants will mix with nanomaterials and diminish their functionalities. Moreover, surfactants are usually toxic to the environment. For these reasons, a generic, efficient, non-destructive, and eco-friendly assembly method is highly desired to unlock the diverse assembly systems.

The present disclosure provides a method for forming a coating such as a nanomaterial coating on a substrate through solute-assisted assembly, and the resulting products comprising such nanomaterial coating. The method can be used in large-scale manufacturing of nanomaterial.

The present disclosure provides an article comprising a nanomaterial coating on a substrate, a method of making the same, and a method of using the same. The coating is made through solute-assisted assembly. The nanomaterial coating includes a layered (2D) nanomaterial such as MXene (e.g., Ti₃C₂Tₓ), which is made of a-few-atoms-thick layers of carbide, nitride, or carbonitride of transition metal.

In accordance with some embodiments, a method for forming a nanomaterial coating comprises steps of: providing a mixture comprising a solvent, a solute, and a nanomaterial, and a combination thereof; applying sonication to the mixture; and contacting a substrate with the mixture so as to form a coating of the nanomaterial onto the substrate. The nanomaterial may be one dimensional (1D), two dimensional (2D), or three dimensional (3D) nanomaterials. The solute may be a salt, a mixture of salts, a mixture of a salt and an acid or a base. The solute is soluble in the solvent. The nanomaterial is not soluble in the solvent. The assembly of the nanomaterial may be assisted in an acoustic field under sonication, or a shear field induced by dip coating, and a shear field induced by mechanical stirring. For example, the nanomaterial may be dispersed, pre-treated, and/or exfoliated after sonication is applied.

In some embodiments, for some hydrophilic nanomaterials in water, sonication might not be necessary.

The nature of the nanomaterials and the substrate can be similar or different. In some embodiments, the nature of the nanomaterials and the substrate are opposite. For example, the nanomaterial is hydrophilic while the substrate is hydrophobic, or the nanomaterial is hydrophobic while the substrate is hydrophilic. In some embodiments, the nature of the nanomaterials and the substrate are similar. For example, both the nanomaterial and the substrate are hydrophilic or hydrophobic. MXene is hydrophilic, while it can be modified to be hydrophobic.

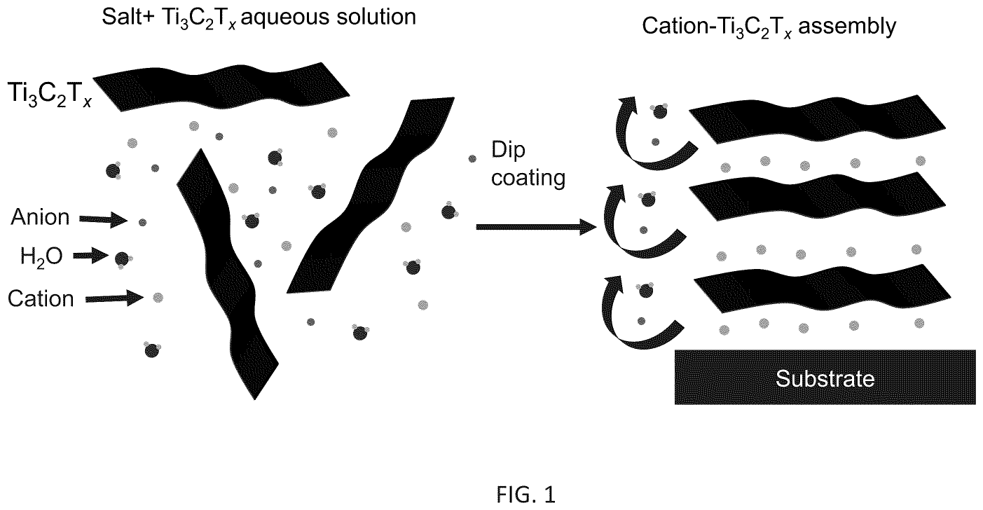

Referring to FIG. 1, a solute assisted assembly (SAA) process has been invented in Villanova University. The nanomaterials may be nanoparticles, nanoflakes, 2D layered nanomaterials, or nanotubes in some embodiments. The assembly system comprises four components: a type of nanomaterial, a solvent, a substrate, and a water-soluble solute. Examples of the nanomaterial include, but are not limited to nanoparticles, nanoflakes, 2D layered nanomaterials, nanotubes, nanofibers, and any combination thereof. A 2D layered nanomaterial such as MXene is illustrated in FIG. 1. Ti₃C₂Tₓ shown in FIG. 1 is one example of MXene. The SAA process described herein is also applicable to nanoparticles and other nanomaterials. The substrate can be a solid of any shape. Examples of a substrate include, but are not limited to, particles, fibers, fabrics, articles, and a portion of an article.

As illustrated in FIG. 1, the solvent may be water or a water-containing solvent. Examples of the substrate include, but are not limited to a polymer, a ceramic, a metal, a glass substrate, a paper, and a combination thereof. The water-soluble solute may be a salt, a mixture of salts, or a mixture of a salt and an acid or a base. In FIG. 1, a salt including cations and anions are illustrated. By adding a solute, the interaction between the particles and the substrate can be modulated by the solvation process of solute leading to the deposition of the particles on the substrate.

Unlike other solution-based methods using chemical treatments such as plasma, acid, or base etching, or adding surfactant to enhance the affinity between the particles and the substrate, the SAA method adds a water-soluble solute as described herein to modulate the interactions among the particles, the solvent (i.e., water) and the substrate so that the nanomaterials assembly on the substrate is energetically favorable. This schematic in FIG. 1 illustrates that the assembled nanomaterials assisted by adding a water-soluble solute such as a salt in water. To modulate the nanomaterial-nanomaterial interactions and prevent the formation of large aggregates after adding the solute such as a salt, acoustic field is applied during the salt adding process. Compared to chemical treatments that damage the chemical structure of the substrate (e.g., breaking chemical bonds by plasma etching), the solutes available in this method do not react with the surface of nanomaterial and substrate and therefore maintain their outstanding properties.

The substrate can be any suitable substrate. In some embodiments, the substrate comprises a polymer, a glass sheet, a ceramic sheet, a metal foil, a paper, or any combination thereof.

The substrate is contacted with the mixture through an acoustic agitated process, a dip-coating process, a roll-to-roll process, a mechanical stirring process, or a combination thereof. For example, a dip coating process or a roll-to-roll process is used in some embodiments.

In some embodiments, the coating comprises layered nanomaterials, and the layered nanomaterials have a size of spacing, which is controlled by species of the solute. The nanomaterial may have a suitable size, for example, in a range of from about

1 nm to about 10 microns. For example, the nanomaterial comprises nanomaterials having at least one dimension in a range of from about 1 nm to about 1,000 nm, for example, from about 10 nm to about 1,000 nm.

In some embodiments, the solute comprises one or more salts, which may be water-soluble. The nanomaterial is hydrophilic, and the substrate comprises a polymer, which may be hydrophobic.

In accordance with some embodiments, a salt is used as the solute in the coating process provided in the present disclosure. Different salt species can be used in this salt assisted assembly process to induce assembly of nanomaterials on hydrophobic substrates. The salt is water-soluble or is soluble in a solvent used in the coating process.

A salt may comprise a metal selected from Columns 1, 2, 13, 14, and 15, and transition metals in the periodic table. Such a metal may be selected from Li, Na, K, Rb, Cs, Mg, Ca, Sr, Ba, Sc, Y, La, Ti, Zr, Hf, V, Nb, Cr, Mo, W, Mn, Re, Fe, Ru, Os, Co, Rh, Ir, Ni, Pd, Pt, Cu, Ag, Au, Zn, Cd, Al, Ga, In, Ge, Sn, Sb, and Bi. An anion may comprise F, Cl, Br, I, N, and O. Any combination that is soluble in water or another solvent used can be used. A salt may comprise a suitable cation, for example, Lit, Na⁺, K⁺, Rb⁺, Cs⁺, Mg²⁺, Ca²⁺, Sr²⁺, Ba²⁺, Al³⁺, Sc³⁰, Cr³⁺, V³⁺, Ti⁴⁺, Mn²⁺, Fe³⁺, Co²⁺, Ni²⁺, Cu²⁺, Zn²⁺, Ga³⁺, Ge⁴⁺, Y³⁺, Zr⁴⁺, Nb⁵⁺, Mo³⁺, Ru³⁺, Re³⁺, Os³⁺, Au³⁺, Bi³⁺, Ir³⁺, Pt⁴⁺, La³⁺, Hf⁴⁺, W⁶⁺, Rh³⁺, Pd²⁺, Cd²⁺, In³⁺, Sn⁴⁺, Sb³⁺, Ag⁺, or any other suitable metal ions. The salt comprises a suitable anion, for example, F⁻, Cl⁻, Br, I⁻, CO₃²⁻, HCO₃″, NO₃″, and SO₄²⁻. The salt is water-soluble. Examples of a suitable salt include, but are not limited to, LiCI, NaCl, KCl, MgCl₂, AlCl₃, CaCl₂, ScCl₃, TiCl₄, MnCl₂, FeCl₃, CoCl₂, NiCl₂, CuCl₂, ZnCl₂, GaCl₃, GeCl₄, YCl₃, ZrCl₄, NbCl₅, MoCl₃, RuCl₃, RhCl₃, PbCl₂, CdCl₂, SbCl₃, CsCl, BaCl₂, LaCl₃, HfCl₄, WCl₆, ReCl₃, OsCl₃, AuCl₃, BiCl₃, NaF, NaBr, Nal, Na₂CO₃, NaNO₃, Na₂SO₄, LiBr, KBr, LiI, KI, and any combination thereof. More than 50 types of salts were used in the experiments.

In accordance with some embodiments, hydrophilic nanomaterials are assembled on the surface of hydrophobic substrate, or hydrophobic nanomaterials are assembled on the surface of hydrophilic substrate. Traditional assembly technologies emphasis the principle of “like assembles on like” meaning the nanomaterials must present affinity to substrates either chemically (through chemical interaction) or physically (through van der Waals interactions). In contrast, the assembly at a heterogeneous interface, i.e., between a hydrophilic nanomaterial and a hydrophobic substrate, is extremely challenging as the solvent with affinity of one of them will easily penetrate such interface and detach the two. In the method provided in the present disclosure, a solute is introduced in aqueous suspension of nanomaterials to force the assembly of hydrophilic nanomaterials on hydrophobic substrate under the agitation of acoustic field.

The solute preferably comprises one or multiple water-soluble salts. The salts can be any salt soluble in water as described herein. The suitable metal ions may be selected from alkali metal ions, alkali metal ions, Group 13 metal ions (such as aluminum ion), and transition metal ions. The suitable anions may be selected from halides, sulfate, nitrate, carbonate, and any other anions providing a water-soluble salt. Examples of a suitable salt include, but are not limited to, LiCI, NaCl, KCl, MgCl₂, AlCl₃, CaCl₂), ScCl₃, TiCl₄, MnCl₂, FeCl₃, CoCl₂, NiCl₂, CuCl₂, ZnCl₂, GaCl₃, GeCl₄, YCl₃, ZrCl₄, NbCl₅, MoCl₃, RuCl₃, RhCl₃, PbCl₂, CdCl₂, SbCl₃, CsCl, BaCl₂, LaCl₃, HfCl₄, WCl₆, ReCl₃, OsCl₃, AuCl₃, BiCl₃, NaF, NaBr, Nal, Na₂CO₃, NaNO₃, Na₂SO₄, and any combination thereof. In some embodiments, the salt is a halide, a sulfate, a nitrate, or a carbonate of an alkali metal or alkali earth metal.

Adding solute such as a salt in the solvent will alter the stability of nanomaterial suspension and force the assembly of nanomaterial on the substrate. Its universality also covers the flexibility in the choices of species of nanomaterials (e.g., different nanoparticles, graphene oxide, and MXene) and substrates (e.g., soft and rigid hydrophobic or hydrophilic polymer), nanomaterial size (e.g., 0.3-10,000 nm), and substrate geometry (e.g., curved substrate). This new method is a platform technology for achieving assembly of nanomaterials on “unlike” substrate toward the application of coatings, smart textiles, and electronics in a low-cost, environment-friendly, and controllable manner.

In accordance with some embodiments, referring to FIG. 1, a universal salt-assisted assembly (SAA) is made from a solution, and ultra-thin and uniform MXene coatings obtained have outstanding mechanical stability and washability on diverse polymers.

In some embodiments, the present disclosure provides an assembly method of nanomaterials on a polymer substrate. This is a simple and highly efficient assembly method for larger scale flexible electronics fabrication. This method does not require a good wetting between solvent and nanomaterials. This method does not need to add any surfactants which may cause decreased properties in some embodiments. This invention does not require a good wetting between solvent and polymer substrate. It is highly efficient and accessible for large scale flexible electronics and functional coating manufacturing.

The substrate can be any suitable material. Examples of a suitable substrate include, but are not limited to, polydimethylsiloxane (PDMS), fluorosilicone, polypropylene polyethylene (PP), polyethylene (PE), polyimide (PI), polyetherimide (PEI), polyvinylidene fluoride (PVDF), thermoplastic polyurethane (TPU), polymethyl methacrylate (PMMA), polyethylene terephthalate (PET), polytetrafluoroethylene (PTFE), polyvinyl chloride (PVC), polyamide such as nylon (e.g., nylon 6), polyetherether ketone (PEEK), acrylonitrile butadiene styrene polymer (ABS), polybenzimidazole (PBI), polycarbonate (PC), polyoxymethylene (POM), epoxy, polyethersulfone (PES), glass slide, copper foil, molybdenum foil, aluminum foil, papers, or any combination thereof. One exemplary polymer is poly(para-phenylene terephthalamide), generally called Kevlar. The substrate such as polymer substrate can be a film, a fiber, a fabric, a sheet, or a three-dimensional object. The PE films can be high density polyethylene (HDPE) film or ultra-high molecular weight (UHMW) film. PP nonwoven or fabric, PET fabric, or Kevlar fiber or fabric can be also used. The film thickness of such a film, a fabric or nonwoven substrate may have a thickness in a range of from 0.1 mm to 0.5 mm.

In some embodiments, the TPU has corresponding structures rendering it hydrophobic. For example, TEXIN® 1209 resin, which is an aromatic polyether-based thermoplastic polyurethane, can be used.

A coating method is provided. For example, a dip coating method provided herein is superior to any existing dip coating method.

In some embodiments, the nanomaterials and proper solvent are mixed together and sonication is introduced for nanomaterials dispersion and exfoliation. A polymer substrate is then immersed into the solution for assembly. The resulting assembled samples are carefully rinsed in a clean solvent and dried.

In accordance with some embodiments, the solvent chosen for exfoliation and assembly does not necessarily have to be a favored solvent for substrate wetting or for the nanomaterials exfoliation.

In some embodiments, DI water, which is a non-toxic but poor wetting solvent for hydrophobic polymer such as polydimethylsilicone (PDMS), is used to exfoliate and/or disperse and then assemble 1D carbon nanotube and different 2D nanomaterials (graphene, h-BN, MoS₂ and MXene) on a substrate. A uniform film can be formed in as short as 10 seconds after dipping the substrate in the mixture of water and nanomaterials and by adjusting the solution concentration and assembly time, the thickness of assembled film can be easily tuned from several nanometers to several tens of micrometers.

The SAA process is a high rate, cost-efficient and environment-friendly manufacturing method for making nanomaterial films. This method can achieve assembly in a solvent such as a water solution, in a short period and with high controllability.

In some embodiments, dispersion of nanomaterials may not be desired in the non-wetting solvents, especially for bulk layered nanomaterials. The exfoliation efficiency is low in bad and surfactant free solvents. This limitation can be overcome by two-step assembly process. The first step is getting a well-exfoliated nanomaterial in any good solvents system. The second step is transferring the exfoliated nanomaterial to non-wetting solvent and then do the assembly.

In some embodiments, the solvent is water. In some other embodiments, the solvent may be aqueous while containing a small amount of ions. The pH value of the solvent may be in a suitable range, for example, from 6 to 8.5 in some embodiments. For electronic application, deionized water is preferred for high purity of the resulting coating.

In some embodiments, no surfactant or other additives are added in the mixture. The mixture may consist of water and hydrophobic nanomaterials.

In some embodiments, the sonication is applied with an energy in a range of from 0.01 watt/cm² to 10 watts/cm². A sonication at low energy is preferred in some embodiments. The frequency may be in in a range of from 20 kHz to 10 MHz, for example, in a range of from 20 KHz to 1 MHz.

In some embodiments, the method is a fast dip coating process, and can be performed much faster than any existing dip coating method. For example, the pre-determined speed is 1 meter/minute or higher. The pre-determined speed can be in a range of from 1 meter/minute to 600 meter/minute (e.g., 1-100 m/min., 1-50 m/min., 10-100 m/min., 5-50 m/min., or any suitable range). The coating method provided in the present disclosure is a break-through technology in the coating field, particularly in dip-coating field.

The substrate may have a flat surface for coating, or have a 3D configuration for coating. The surface roughness may not be critical. So a smooth or rough surface can be good for coating nanomaterials using the method provided in the present disclosure. The substrate may be dipped into the mixture and pulled out from the mixture at any suitable angle. The coating process is self-limiting and will reach an equilibrium status after a certain period of time such that the thickness of the film will not increase with the increase of assembly time.

The method is performed at a processing temperature in a range from a freezing point to the boiling point of the solvent used. In some embodiments, the dipping step for coating is performed at a temperature in a range of from 20° C. to 100° C. (e.g., RT to 50° C.).

In accordance with some embodiments, an article provided in the present disclosure comprises at least one coated layer, which comprises a substrate and a coating disposed on the substrate. The coating comprises a layered nanomaterial and a solute embedded and uniformly distributed in the layered nanomaterial. The solute comprises at least one salt soluble in a solvent, and the substrate comprises a polymer.

The nanomaterial has at least one dimension in a range of from about 1 nm to about 1,000 nm. The layered nanomaterial has a thickness in a range of from about 1 nm to about 1,000 nm, for example, in a range of from about 4 nm to about 1,000 nm.

The layered nanomaterial comprises nanosheets of MXene. MXene is a layered nitride, carbide, or carbonitrides of at least one transition metal (M) having a formula of Mₙ₊₁XₙTₓ. X is nitrogen or carbon, n is an integer representing the number of layers of nitrogen or carbon, n+1 is the number of layers of the at least one transition metal, T is a functional group, and x is in a range of from 0 to 2. In some embodiments, n is in the range of from 1 to 3. Examples of T include, but are not limited to F, Cl, O, OH, and a combination thereof.

In some embodiments, the MXene has a formula of Ti₃C₂Tₓ.

In some embodiments, the 2D nanomaterial (nanosheet) used such as MXene has a single-layered structure or have several layers, for example, any suitable number of layers in a range of from 2 to 10. In some embodiments, the MXene nanosheets used is negatively charged during the coating process so as to prevent aggregation of the nanosheets.

In the coating, the layered nanomaterial is oriented in a plane substantially parallel to a surface of the substrate.

The nature of the nanomaterials and the substrate can be similar or different. In some embodiments, the nature of the nanomaterials and the substrate are opposite. For example, the nanomaterial is hydrophilic while the substrate is hydrophobic, or the nanomaterial is hydrophobic while the substrate is hydrophilic. In some embodiments, the layered nanomaterial such as MXene is hydrophilic while the substrate is hydrophobic.

The substrate can be any suitable substrate of any chemical composition and of any shape. In some embodiments, the polymer in the substrate is in a form of a film, or a fabric comprising fibers.

Examples of a suitable polymer include, but are not limited to polyether ether ketone (PEEK), polyvinylidene fluoride (PVDF), polytetrafluoroethylene (PTFE), polyethene (PE), polypropylene (PP), polyethylene terephthalate (PET), polybenzimidazole (PBI), polycarbonate (PC), polyether sulfone (PES), polyoxymethylene (POM), polyethylenimine (PEI), acrylonitrile butadiene styrene (ABS), poly(phthalaldehyde) (PPA), polyurethane (PU), a polyamide, and any combination thereof.

In some embodiments, the polymer is a high-performance polymer such as PEEK or poly(para-phenylene terephthalamide). In some embodiments, the substrate comprises fibers or fabrics, which may be made of a high-performance polymer such as PEEK and poly(para-phenylene terephthalamide).

The at least one salt comprises a metal cation and an anion. For example, examples of a suitable metal ion include, but are not limited to Lit, Na⁺, K⁺, Rb⁺, Cs⁺, Mg²⁺, Ca²⁺, Sr²⁺, Ba²⁺, Al³⁺, Sc³⁰, Cr³⁺, V³⁺, Ti⁴⁺, Mn²⁺, Fe³⁺, Co²⁺, Ni²⁺, Cu²⁺, Zn²⁺, Ga³⁺, Ge⁴⁺, Y³⁺, Zr⁴⁺, Nb⁵⁺, Mo³⁺, Ru³⁺, Re³⁺, Os³⁺, Au³⁺, Bi³⁺, Ir³⁺, Pt⁴⁺, La³⁺, Hf⁴⁺, W⁶⁺, Rh³⁺, Pd²⁺, Cd²⁺, In³⁺, Sn⁴⁺, Sb³⁺, Ag⁺, and a combination thereof. The anion may be F⁻, Cl⁻, Br⁻, I, CO₃²⁻, HCO₃, NO₃″, SO₄²⁻, or a combination thereof. The at least one salt is water-soluble.

In some embodiments, the solute comprises one or more salts.

In some embodiments, the layered nanomaterials have a size of spacing, which is controlled by species of the solute such as salt. In some embodiments, the coating comprises layered nanomaterials, and the layered nanomaterials have a size of spacing controlled by species of the solute such as the salt used. Selection of metal ion of the salt is used to adjust the size of spacing between adjacent nanosheets. In some embodiments, the metal ions from the salt used are bound with MXene nanosheets and are uniformly distributed across the nanosheets.

In some embodiments, the coating may have a thickness in a range of from about 1 nanometer to about 1,000 nm, for example, from 4 nm to 1,000 nm, from 10 nm to 1,000 nm, from 10 nm to 900 nm, from 10 nm to 800 nm, or any other suitable ranges. In some embodiments, the nanomaterials are chemically bonded with each other in the coating.

The 2D layered nanomaterial is oriented parallel to the surface of the substrate. The coating may have good adhesion on the substrate and cannot be rubbed off.

The coating is electrically and/or thermally conductive, and the article is configured to be used for thermal management. The electric conductivity and thermal conductivity of the coating can be adjusted based on the applications.

In some embodiments, the article further comprises at least two electrodes connected with the coating and configured to provide Joule heating.

In some embodiments, the at least one coated layer in the article comprises a first coated layer and a second coated layer the same as the first coated layer. The article further comprises a separation layer disposed between the first coated layer and the second coated layer.

In some embodiments, the article is configured to be wearable and protective and may provide thermal management functions. For example, the article is a protective garment or gear.

### 1. CONDITIONS OF SOLUTE-ASSISTED ASSEMBLY PROCESS

The general conditions and parameters are described herein for illustration purpose only.

A nanomaterial aqueous solution and a solute solution (or pure solute) with certain concentrations were prepared respectively, and both solutions are mixed together under sonication. In this way, a solute-nanomaterial solution was fabricated. The term “nanomaterial solution” may be understood as a suspension of particles. The concentrations of the resultant solute and particle solution were determined, respectively. Because the aggregation would occur when mixing solute and nanomaterial solution, the solute-nanomaterial solution was then sonicated with stirring for 30 minutes to achieve proper dispersing. A lab-made dip coater was then used to realize the dip-coating assembly process on various substrates. In the experiments described herein, the substrates were immersed in the solution during the whole assembly process. The assembled nanomaterial on respective substrates were dried by nitrogen gas to remove excess solute-particle solution. The resultant sample was further rinsed by DI water to remove excessive solute deposited on the surface of nanomaterials and dried using nitrogen gas. A small amount of solute will remain on the surface of nanomaterials and cannot be removed by the rinsing process in some embodiments.

1.1. Processing Conditions: three ways and combinations thereof were tried to agitate the solution to enhance the nanomaterials/particles dispersion and energize the particles to speed up the assembly process: (a) sonication; (b)dip coating; (c) roll-to-roll process, mechanical stir, and any combination of these processes including (a), (b), and/or (c). In most of the experiments described herein, dip coating plus sonication assembly method was used. Stirring can be used for the assembly of some materials. The sonication with a frequency of 40 Khz and an intensity of <10 mW/cm² was used. However, any other frequency in the range of from 20 KHZ to 100 MHz can be used. The sonication intensity may be in a range of from 10 mW/cm² to 4×10⁴ W/cm². The dip coating speed may be 1 meter/second.

1.2. Substrate species and direction: One exemplary substrate used in the experiments was a polymer substrate. The substrate or the polymer substrate is understood to encompass different shapes such as fibers and fabrics made of such fibers. For example, in one exemplary polymer substrate is made of PDMS, which has a ratio of DMS monomer and cross-linking agent was 10:1. Such a ratio can be adjusted in a range from 60:1 to 2:1, which also works for the assembly process. Other suitable substrates as described above such as polymers including, but not limited to Kevlar, PP, HDPE, UHMWPE, PVDF, PET, PEEK, ABS, PC, epoxy, PES, PA-6, PI, PBI; metals; glass, ceramics have been validated to work as well.

1.3. Period of time for coating: The assembly time was 15 min in the experiments for the data presented herein. The period of time for coating can be adjusted according to different particles and substrates. The coating time or the assembly time can be in a range from several seconds to several hours.

1.4. Temperature of solution in sonicator: The assembly process can be performed at any suitable temperature, for example, from freezing temperature (0° C.) to an increased temperature (99° C.). The experiments described herein were performed at 50° C. during sonication. When sonication is on, the solution will be heated up.

1.5. Solvent: Any suitable solvent such as deionized water or other organic solvent (e.g., acetone, alcohol) can be used. In the experiments described herein, deionized water was used. The solvent should not dissolve substrate or damage the required structural and mechanical integrity of the substrates unless such requirement is compromised by a specific application. For example, for applications requiring structural/mechanical integrity of the substrate such as electronics and safety textiles, the solvent should not dissolve or even swell the substrate. However, some applications, e.g., sensing application, may require swell the substrate to embed particles into the surface, the solvents that can swell the substrate can be used. In all cases, the solvent and the solute added may modify the surface properties of particle and substrate, such modification is allowed.

1.6. Solute species: The solute used in the method provided in the present disclosure include a salt (e.g., NaCl, KCl, or a combination thereof) or a combination of different salts. A hybrid solute such as mixtures of multiple salts or a combination including any combination of salt and acid or base can be also used. For a hybrid solute, the individual solutes should not react to each other. For the selection criterion, the solute can be dissolved in the solvent (e.g., deionized water). Meanwhile, the formed solution should not dissolve the substrate or damage the required structural and mechanical integrity of the substrates. In addition, surface modification is allowed for both particles and substrates.

1.7. Solute concentration: the concentration of the solute in the solution can be in a range of from 0.000001% by weight or 0.001 mol/L to a saturated concentration at room temperature in the corresponding solvent such as deionized water. The saturation concentration can be increased by increasing the temperature. Each solute has its specific saturated concentration at different temperatures.

1.8. Concentration of nanomaterial: the nanomaterials may have any suitable concentration in the solution, for example, 0.01-500 mg/mL, 0.1-100 mg/mL, 0.5-50 mg/mL, or 0.5-20 mg/mL. In some embodiments, a concentration in a range of 0.1-100 mg/mL was used.

The nanomaterials are insoluble in the solvent or have negligible solubility in the solvent. In some embodiments, this particle concentration may be lower or higher than 10 mg/mL due to the properties of various particles.

1.9. Nanomaterial size: the particles used may have a size ranging from several nanometers to tens of micrometers.

1.10. The pH value of the solution: The solution can be neutral, acidic or basic. The pH value of solution can be adjusted in consideration of the particles and the substrate.

1.11. Nanomaterial species: The nanomaterials can be of any suitable type as described herein. In some embodiments, the nanomaterial used is MXene.

### 2. EXAMPLES

The examples are described herein for illustration purpose only. A general experimental procedure is described using MXene as an exemplary nanomaterial to be coated. MXene is hydrophilic and is used in aqueous solutions. Hydrophobic or hydrophilic polymer substrates were used. For example, silicone was used as an example for a hydrophobic polymer substrate.

2.1. Synthesis of Ti₃C₂Tr Nanosheet Solution:

Ti₃C₂Tₓ was synthesized by the selective etching of Ti₃AIC₂ MAX phase powder (<40 μm particle size, Carbon-Ukraine) with a mixture of hydrofluoric (HF) (29 M, Acros Organics) and hydrochloric (HCl) (12 M, Fisher Chemical) acids. First, 2 mL of HF, 12 mL of HCl, and 6 mL of de-ionized (DI) water were combined. After that, 1 g of MAX phase powder was added to the solution and stirred for 24 h at 35° C. After etching, the reaction product was washed with DI water through 5-minute centrifugation cycles at 3500 rpm until pH exceeded 6. The obtained sediment was dispersed in 20 ml of 1 mol L−1 LiCI solution for Li+intercalation, and the reaction was allowed to proceed for 12-24 h at 300 rpm and 35° C. The mixture was then washed with DI water to remove excess LiCl using 10-minute centrifugation cycles at 3500 until the supernatant darkened and the sediment swelled. Then a final washing cycle was performed at 3500 rpm for 1 hour. The resulting clear supernatant was decanted and exchanged with DI water to redisperse the sediment with agitation. The mixture was centrifuged at 3500 rpm for 10 min, with the dark supernatant being collected as a single layer Ti₃C₂Tₓ dispersion. Sediment redispersion, 10-minute centrifugation at 3500 rpm, and supernatant (Ti₃C₂Tₓ) collection were repeated till the supernatant became clear.

2.2. Assembly of Ti₃C₂Tₓ Nanosheets on Polymer Substrates:

A MXene colloidal solution was diluted by adding prepared salt solution. In this way, salt-MXene solution was fabricated, where the resultant salt concentration and MXene solution are 0.01 mol/L and 10 mg/mL, respectively. Because the aggregation will occur when mixing salt and MXene solution, forming gel-like MXene, of which the high viscosity makes the later assembly process unreachable, the salt-MXene solution was then sonicated with stirring for 30 minutes for the aim of dispersing. A lab-made dip coater was used to realize the dip-coating assembly process on various substrates. The substrates were immersed in the solution during the whole assembly process. The assembled MXenes on substrates were dried by nitrogen gas to remove excess salt-MXene solution. The salt crystals remained in the MXene assemblies were rinsed off by DI water following nitrogen gas drying. In this general procedure, MXene can be replaced with any other nanomaterials as described herein. The concentrations can be also adjusted.

Ti₃C₂Tₓ used herein is one exemplary MXene and is titanium carbide (Ti₃C₂) having 2D layered structures. MXene used had an average monolayer thickness and lateral size of 1.8 nm and 676.8 nm. The substrate is in the solution while the solution is under sonication during the assembly.

To demonstrate the effectiveness of solution assisted assembly, a hydrophilic material, Ti₃C₂Tₓ (a type of MXene), and a hydrophobic polymer substrate such as PDMS, are chosen to assembly in water. A solution comprising MXene (Ti₃C₂Tₓ) was obtained by an etching method using a mixture of LiF and HCl. The concentration of MXene solution was 10 mg/mL. A type of salt, NaCl, was added to Ti₃C₂Tₓ/water solution (the molar concentration of NaCl in the mixed solution is 0.01 mol/L) and acoustic field (40 KHz, 60 W) is applied during the mixing process to prevent the formation of large aggregation of Ti₃C₂Tₓ. After mixing of salt and solution, the substrate is submerged into the NaCl/Ti₃C₂Tₓ/water solution. After 15 minutes, the substrate with MXenes assembled is obtained after washing with deionized water and drying using N₂ gas.

A general experimental procedure was used for different substrates. A Ti₃C₂Tr nanosheet colloidal solution (10 mg L−1, 10 mL) was diluted by adding a prepared salt solution (0.02 mol L−1, 10 mL). In this way, the salt-Ti₃C₂Tₓ solution was fabricated, where the resultant salt and Ti₃C₂Tr nanosheet concentrations were 0.01 mol L−1 and 5 mg mL-1, respectively. Because the Ti₃C₂T nanosheets aggregation occurs when mixing salt and Ti₃C₂Tₓ nanosheet solutions, the salt-Ti₃C₂T, solution was sonicated for 15 min in a sonication bath (40 kHz, 60 W) to disperse Ti₃C₂Tₓ nanosheet. A customized dip coater (average dipping speed=1.524 m min-1) was used to coat various polymer substrates. The polymer substrates were submerged in the solution during the whole assembly process. The assembled Ti₃C₂Tr coatings on polymer substrates were dried with flowing compressed nitrogen gas to remove the excess solution. To prevent salt crystals from precipitation from the solution during drying, a DI water rinsing step was applied to the dried surface, followed by another round of nitrogen gas drying.

### 2.3. Characterization:

The X-ray diffraction (XRD) analyses of Ti₃AlC₂ MAX phase powder, pristine Ti₃C₂Tₓ film made by drop-casting on a glass slide, and Ti₃C₂Tₓ assemblies on PDMS substrates obtained by SAA method were performed on a Rigaku Miniflex X-ray Diffractometer (40 kV and 15 mA) with Cu Kα radiation and a scanning speed of 10° min⁻¹. The Ti₃C₂T, nanosheet size distribution was measured by the dynamic light scattering (DLS) (Malvern Zetasizer Nano ZS, Malvern Instruments) using a solution diluted to 0.01 mg mL⁻¹.

The monolayer Ti₃C₂Tₓ nanosheet thickness on Si/SiO₂ wafer was determined by atomic force microscopy (AFM) (Park Systems NX10) in a noncontact mode. The contact angle of water and salt solutions (˜5 μL) on polymer substrates and Ti₃C₂Tr nanosheet films was measured using a lab-made contact angle tester. The scanning electron microscope (SEM) images and x-ray energy dispersive spectrum (EDS) mapping of Ti₃C₂Tₓ assemblies on different polymer films and fibers were acquired using a field emission scanning electron microscope (FE-SEM) (Hitachi S−4800 SEM) at 20 kV and 20 mA without sputtering. For the tilted angle view SEM images of the samples, a 6 nm gold layer was coated on both, the top surface and the side of the samples. The high angle annular dark field (HAADF) images, electron diffraction spectroscopy (EDS), and elemental mapping measurements were performed with double-corrected Titan cubed Themis G2 operated at 300 kV in the Electron Microscopy Center (EMC) of Shared Equipment Authority (SEA) at Rice University. The microscope is equipped with a Ceta camera, Gatan Quantum 966 energy filter, and an electron monochromator. Fourier transform infrared spectroscopy (FTIR) spectra of vacuum filtrated cation-Ti₃C₂Tr films were collected by a PerkinElmer FT-IR spectrometer 2000 in the wavenumber range of 1000-4000 cm⁻¹ at a resolution of 1 cm⁻¹.

X-ray photoelectron spectra (XPS) were obtained using a PHI VersaProbe 5000 spectrometer (Physical Electronics, U.S.) with a monochromatic Al Ka X-ray source (1486.6 eV) at a 200 um spot size and 50 W power. The spectra were collected with a 23.5 eV pass energy and an increment of 0.05 eV. All samples were mounted on conductive carbon tapes and electrically grounded via copper tape. High-resolution XPS data were fitted using the CasaXPS software package, employing a Tougaard background for transition metal-based species. The chemical states of Ti₃C₂Tₓ MXene and the cations were deduced from core-level spectral fits. Raman spectra of Ti₃C₂Tₓ and SAS Ti₃C₂T, coatings on polymer substrates were obtained using a WITec alpha300 confocal Raman microscope at an excitation laser wavelength of 785 nm with an ×20 objective. The integration time was fixed to 2 seconds. The thickness and roughness of salt-treated Ti₃C₂Tr assemblies on PDMS were measured by a Keyence VK-X1000 optical profilometer. The sheet resistance of salt-treated Ti₃C₂Tr assemblies was determined by four-point probe measurements (Jandel ResTest). For each sample, 10 points were measured, where the average value was presented, and the standard deviation was calculated as an error.

The surface temperature of Na—Ti₃C₂Tr assemblies on PEEK film and Kevlar fabrics is recorded by an IR camera (HIKMICRO B20). The distance between the sample and the IR camera lens is fixed at 0.3 m, and the detected wavelength ranges from 8 to 14 μm. The absorbance/emissivity of salt-treated Ti₃C₂Tₓ assemblies at different temperatures was tested using an FTIR spectrometer (Invenio-X, Bruker, Germany). An emission adapter (A540/3) was used to heat the samples and the black body reference (a soot layer on the metal sheet). The emissivity in the 5-25 um range is given by the ratio of sample emission (v) and the reference emission at the same temperature (T).

### 2.4. Results

Many related studies were conducted. For the conciseness of the present disclosure, some results are described without showing the images or the detailed data.

Ti₃C₂Tₓ as an exemplary MXene was assembled on a PDMS substrate assisted by NaCl as the solute in water. The resultant scanning electron microscope (SEM) images of the top view and the fractured cross section at a tilted angle view show the success of the assembly.

Four-point probe electrical measurement of resultant sample shows the electrical conductivity of Ti₃C₂Tₓ assemblies (˜20,000 S/cm) approaches the highest reported values for Ti₃C₂Tₓ (up to 25,000 S/cm). The electrical conductivity of Ti₃C₂Tₓ assemblies here (˜20,000 S/cm) is one of the highest values (up to 25,000 S/cm according to the reference) reported yet. This electrical measurement results suggest a suitable salt such as NaCl included will not significantly damage the properties of particles.

To illustrate the effectiveness of solute assisted assembly method, a comparison experiment was designed to assemble Ti₃C₂Tₓ with and without adding NaCl in water. The SEM images of bare PDMS substrate and Ti₃C₂Tₓ assembly on PDMS with and without NaCl were compared. Hydrophilic Ti₃C₂Tₓ cannot be assembled on hydrophobic polymer substrates without adding a solute such as NaCl, but the assembly can occur when adding NaCl. The concentrations of Ti₃C₂Tₓ and NaCl are 5 mg/mL and 0.01 mol/L, respectively.

It was demonstrated that different salt species can be used in this salt assisted assembly system to induce assembly of the nanomaterials such as MXene on hydrophobic substrates. Examples of a suitable salt include, but are not limited to, LiCI, NaCl, KCl, MgCl₂, AlCl₃, CaCl₂), ScCl₃, TiCl₄, MnCl₂, FeCl₃, CoCl₂, NiCl₂, CuCl₂, ZnCl₂, GaCl₃, GeCl₄, YCl₃, ZrCl₄, NbCl₅, MoCl₃, RuCl₃, RhCₗ₃, PbCl₂, CdCl₂, SbCl₃, CsCl, BaCl₂, LaCl₃, HfCl₄, WCl₆, ReCl₃, OsCl₃, AuCl₃, BiCl₃, NaF, NaBr, Nal, Na₂CO₃, NaNO₃, Na₂SO₄, other salts described in the present disclosure, and any combination thereof. In some embodiments, the salt is a halide, a sulfate, a nitrate, or a carbonate of an alkali metal or alkali earth metal.

Salt species and concentration can affect the assembly process and the resultant structures. The salt can be used in a concentration in a range from 0.001 mol/L to a respective saturated solution at room temperature. The saturation concentration can be extended by increasing the temperature.

The fractured surface and the top surface of Ti₃C₂Tₓ assembled on PDMS substrate assisted by KCl salt were also examined under SEM. The Energy Dispersive

Spectroscopy (EDS) mapping of elements including K element were also obtained. The EDS mapping results demonstrate that Ti₃C₂Tₓ can also be assembled on PDMS assisted by a salt such as KCl with uniform structure. The potassium element from KCl can be absorbed on the Ti₃C₂Tₓ surface with uniform distribution.

Similar phenomenon can also be extended to the addition of other salts, for example, NaCl, CsCl, MgCl₂, AlCl₃, or any combination thereof. The concentration of different salts in the final solution was 0.01 mol/L and the Ti₃C₂Tₓ concentration was 5 mg/mL.

Adding a salt to the assembly system affects the particle-particle distance in the assembly. For layered material such as Ti₃C₂Tₓ, such a distance (d-spacing) can be reflected by measuring the changes in interlayer spacing through X-ray powder diffraction (XRD). As shown in Table 1, ions from the salts can be absorbed by the particles and enlarge the interlayer spacing. The notations used herein such as Li—Ti₃C₂Tₓ, Na—Ti₃C₂Tₓ, K—Ti₃C₂Tₓ, Cs—Ti₃C₂Tₓ, Mg-Ti₃C₂Tₓ, and Al—Ti₃C₂Tₓ represent the samples with a salt used being LiCI, NaCl, KCl, CsCl, MgCl₂, and AlCl₃, respectively. The same definitions are applicable to the samples in the present disclosure.

TABLE 1

| | | d-spacing along (002) |
|---|---|---|
| Sample | 2θ (°) | plane (Å) |
| Ti₃AlC₂ | 9.50 ± 0.00 | 9.30 |
| Ti₃C₂Tₓ | 7.40 ± 0.06 | 11.94 |
| Li—Ti₃C₂Tₓ | 6.25 ± 0.05 | 14.13 |
| Na—Ti₃C₂Tₓ | 6.68 ± 0.10 | 13.22 |
| K—Ti₃C₂Tₓ | 6.43 ± 0.10 | 13.73 |
| Cs—Ti₃C₂Tₓ | 6.45 ± 0.05 | 13.69 |
| Mg—Ti₃C₂Tₓ | 6.33 ± 0.08 | 13.95 |
| Al—Ti₃C₂Tₓ | 6.05 ± 0.09 | 14.60 |

The Raman spectra of Ti₃C₂Tₓ assemblies assisted by different salts were used to confirm that adding a salt to the assembly system does not affect the chemical structure of the nanomaterial.

Table 2 illustrates the controllability of the thickness of the assembled Ti₃C₂Tₓ

with respect to the assembly time for different salt additions.

TABLE 2

| Assembly | Coating thickness of assembled Ti₃C₂Tₓ on PDMS with different salts (nm) | | | | | |
|---|---|---|---|---|---|---|
| time (min) | LiCl | NaCl | KCl | CsCl | MgCl₂ | AlCl₃ |
| 1 | 15.1 ± 7.9 | 6.1 ± 5.9 | 8.8 ± 6.6 | 35.1 ± 24.7 | 83.3 ± 67.2 | 95.8 ± 83.4 |
| 2 | 18.2 ± 8.9 | 11.6 ± 9.4 | 10.4 ± 7.6 | 42.3 ± 29.1 | 89.0 ± 58.3 | 182.9 ± 125.7 |
| 5 | 56.2 ± 36.9 | 38.8 ± 24.9 | 90.1 ± 47.6 | 443.7 ± 226.3 | 276.4 ± 153.8 | 437.1 ± 243.9 |
| 10 | 101.0 ± 36.4 | 90.4 ± 31.0 | 120.1 ± 53.3 | 621.4 ± 309.1 | 323.3 ± 149.7 | 906.4 ± 476.8 |
| 15 | 247.1 ± 58.4 | 131.5 ± 39.7 | 257.5 ± 96.4 | 1784.0 ± 498.4 | 1189.3 ± 724.3 | 1473.1 ± 567.5 |

The assembly process of SAA can be controlled by the assembly time. This results in Table 2 demonstrate that the coating thickness of assembled Ti₃C₂Tₓ can be controlled at nanoscale accuracy (e.g., from 6.1 nm to 1784 nm by assembly time from 1 minute to 15 minute). The coating thickness can be adjusted by tailoring the salt species and assembly time. The thickness can be controlled from monolayer Ti₃C₂Tₓ (1.8 nm in thickness) to multilayer stacks (up to several micrometers).

The assembly properties of SAA can be controlled by the assembly time and using different salts. For example, Table 3 shows the controllability of the sheet resistance of the 10 assembled Ti₃C₂Tₓ with respect to the assembly time for different salt additions. The results as shown in Table 3 demonstrate that the sheet resistance of assembled particles can be controlled by assembly time and salt selection.

TABLE 3

| Assembly | Sheet resistance of assembled Ti₃C₂Tₓ on PDMS with different salts (Ω/sq) | | | | | |
|---|---|---|---|---|---|---|
| time (min) | LiCl | NaCl | KCl | CsCl | MgCl₂ | AlCl₃ |
| 1 | 1432 ± 325 | 1038 ± 284 | 881 ± 269 | 492 ± 84 | 592 ± 293 | 273 ± 172 |
| 2 | 1284 ± 264 | 509 ± 231 | 428 ± 84 | 204 ± 46 | 140 ± 60 | 82 ± 30 |
| 5 | 318 ± 19 | 226 ± 72 | 102 ± 21 | 63 ± 18 | 42 ± 23 | 47 ± 5.7 |
| 10 | 92 ± 8 | 50 ± 9 | 16 ± 5 | 4.2 ± 0.7 | 3.2 ± 3.0 | 34 ± 3.8 |
| 15 | 4.7 ± 0.3 | 3.7 ± 0.6 | 3.2 ± 0.6 | 3.4 ± 0.2 | 3.1 ± 0.6 | 10 ± 0.8 |

Ti₃C₂Tₓ assembly assisted by a salt such as NaCl were also obtained on 3D printed PDMS substrates with complicated structure including holes. A PDMS substrate is transparent or have a light color before coating. After coating with Ti₃C₂Tₓ, the sample surface is black. The result demonstrates that a solute assisted assembly (SAA) process is independent on the substrate shape and morphology. The method and the coating structure as described herein can be applicable to various substrates of different shapes and configurations.

The SAA method as described herein can be generalized to a wide range of substrates from organic polymer substrates to metal and ceramic substrates. Similar phenomenon can be extended to PP, HDPE, UHMWPE, PVDF, PET, PEEK, ABS, PC, epoxy, PES, PA-6, PI, Kevlar, and PBI as a substrate.

As described, nanomaterials such as MXenes can be assembled on different substrates, which can be flat or non-flat configuration. The substrates may be films made of a polymer such as the PDMS (10:1) substrate described. The nanomaterials such as MXenes can be also assembled on a patterned polymer (such as PDMS) substrate. The substrates such as polymer substrates are hydrophobic. The nanomaterials such as MXenes can be assembled on various hydrophobic polymer (such as PP and Kevlar) microfibers.

These results demonstrate that the SAA process can be used to assemble particles such as Ti₃C₂Tₓ on polypropylene (PP) fibers as exemplary fibers. According to the diameter of the fibers and pore size of the textiles, the particles can bridge multiple fibers and/or wrap single fiber. Similar assemblies are demonstrated on PET fibers, UHMWPE fibers, and Kevlar fibers.

The nanomaterial assemblies were also obtained using different combinations of solutes and/or nanomaterials. For example, these combinations include, but are not limited to salt combination (e.g., NaCl and KCl) and one nanomaterial species; nanomaterial combination and one salt (e.g., NaCl) species; salt combination (e.g., NaCl and KCl) and nanomaterial combination.

As described herein, the present disclosure provides an article comprising a substrate and a coating disposed on the substrate. The coating comprises a nanomaterial and a solute distributed in the coating. The solute comprises a salt or a combination of salts in some embodiments. The solute is soluble in a solvent such as water or water-containing mixture solvent. The nanomaterial may be hydrophilic while the substrate is hydrophobic, or the nanomaterial is hydrophobic while the substrate is hydrophilic.

The nanomaterial may be 2D (layered) nanomaterials. The substrate may comprise a polymer, a glass sheet, a metal foil, a paper, or a combination thereof. In some embodiments, the substrate comprises fibers or fabrics made of a high-performance polymer such as PEEK or Kevlar.

The nanomaterial may have a suitable size, for example, in a range of from about 1 nm to about 10 microns. For example, the nanomaterial comprises nanomaterials having at least one dimension in a range of from about 1 nm to about 1,000 nm, for example, from about 10 nm to about 1,000 nm.

In some embodiments, the solute comprises one or more water-soluble salts. The nanomaterial is hydrophilic, and the substrate comprises a polymer, which may be hydrophobic

In some embodiments, the coating comprises layered nanomaterials, and the layered nanomaterials have a size of spacing controlled by species of the solute.

The coating may have a thickness in a range of from about 1 nanometer to about

100 microns, for example, from 1 nm to 100 nm, from about 1 micron to 100 microns, or any suitable thickness.

In some embodiments, the nanomaterials are chemically bonded with each other in the coating. For example, the nanomaterials are hydrophilic and contains hydroxyl groups on the surface. The hydroxyl groups react with each other to provide chemical bonding. For some hydrophobic nanomaterials without any active groups on the surface, the nanomaterials are held together with each other in the coating through Van der Waals force.

MXenes are promising water-processable coating materials with excellent electrical conductivity, and thermal and optical properties. However, deposition of hydrophilic MXene nanosheets on inert and/or hydrophobic surfaces of polymer or textiles requires plasma treatment or chemical surface modification.

In the present disclosure, referring to FIG. 1, a universal salt-assisted assembly (SAA) is made from a solution, and ultra-thin and uniform MXene coatings obtained have outstanding mechanical stability and washability on diverse polymers.

For example, these include many of important hydrophobic polymers such as polyethylene (PE), polyetheretherketone (PEEK), poly(tetrafluoroethylene) (PTFE), and poly-paraphenylene terephthalamide (Kevlar). The salt added to the Ti₃C₂Tₓ aqueous colloid neutralizes MXene's surface charge and deposits MXene onto the polymer surface. Molecular dynamics simulations suggest a decreasing interlayer spacing due to the expulsion of water molecules and anions, while cations are trapped between the MXene layers. A library of salts as described herein has been used to tailor the assembly kinetics and coating morphology.

Hydrophilic Ti₃C₂Tₓ nanosheets were obtained through etching Ti₃AIC₂ MAX phase and subsequent lithium-ion intercalation of the produced multilayer MXene. In some examples, hydrophobic polydimethylsiloxane (PDMS) was chosen as one exemplary substrate for demonstration because its molecular-level flat surface facilitates structural characterization (e.g., thickness and roughness) of MXene coating. In an aqueous solution, hydrophilic single-and few-layer Ti₃C₂Tₓ nanosheets are dispersed uniformly as their negatively charged surface prevents aggregation of the nanosheets. Dipping PDMS substrate into pristine MXene solution using a customized dip coater through a high-speed cyclic dipping process at an average dipping speed of 1.524 m min⁻¹ resulted in poor assembly. However, after adding 0.01 mol L⁻¹ NaCl to Mexene (Ti₃C₂Tₓ) aqueous solution and then dipping PDMS substrate into the salt-added MXene solution, a uniform coating of Ti₃C₂Tₓ nanosheets on PDMS was produced.

For chloride salt-assisted assembly of Ti₃C₂Tₓ in some embodiments, the cation was used to denote the samples. For example, Na—Ti₃C₂Tr represents Ti₃C₂Tₓ coating produced with NaCl. Salt ions are embedded in the assembled structures, as shown in an element mapping where both Na from salt and Ti from MXene are uniformly distributed across the entire surface. But this concentration of NaCl allows deposition of Ti₃C₂Tₓ (after a 15-min dip coating and 132 +40 nm in thickness) with the electrical conductivity of ˜20,500 S cm⁻¹, which is comparable to the best-reported values of Ti₃C₂Tₓ films. Salt solutions with a higher concentration (up to saturated solution) can also be used, providing a process variable that can be used to control the assembly kinetics and the resultant MXene coating architecture. For example, the concentration of NaCl used include 1 mol/L, 3 mol/L, and 6 mol/L, and good coatings of MXene on PDMS were obtained.

SAA is a universal assembly method for substrates of different nature, for example, hydrophobic and hydrophilic polymers. Ti₃C₂Tr coatings on different polymers were obtained. Examples of these polymers used include, but are not limited to PEEK, PVDF, PTFE, HDPE, UHMWPE, PET, PBI, PC, PES, POM, PP, PEI, ABS, PPA, PU, and polyamide such as PA 6,6. These polymers include ones with the highest mechanical strength and thermal resistance, such as hydrophilic polyimide, and hydrophobic PE, Kevlar, and PEEK. Among these polymers, examples of an amorphous polymer include, but are not limited to ABS. PC, PEI, PES, and PBI. Examples of a semicrystalline polymer include, but are not limited to HDPE, UHMWPE, PP, PVDF, POM, PA 6,6, PET, PPS, PTFE, PEEK, and Kevlar.

The names of coated samples were abbreviated using “nanomaterial on substrate,” or “nanomaterial @ substrate,” or “nanomaterial/substrate.” These formats are interchangeable. For example, “Na—Ti₃C₂Tr on PEEK,” which is the same as “Na—Ti₃C₂Tr @ PEEK” or “Na—Ti₃C₂Tr/PEEK,” refers to one MXene Ti₃C₂Tr nanosheets assembled on a PEEK substrate, in which sodium containing salt such as NaCl was used for the SAA process and is embedded or trapped inside the Ti₃C₂Tr nanosheets.

Before the adoption of SAA, many of those polymers needed complicated chemical modifications to be coated from aqueous dispersions. However, with the utilization of SAA, all of them can be coated uniformly with Ti₃C₂Tₓ, as confirmed by SEM images.

Furthermore, as shown in Table 4, the thicknesses and electrical conductivities of the MXene coatings are compared to the ones on PDMS. Table 4 shows the results including roughness, sheet resistance, and thickness of Na—Ti₃C₂Tₓ assemblies on various polymer substrates. The assembly time for each sample was fixed at 15 minutes. The concentrations of Ti₃C₂Tₓ nanosheet and NaCl were 5 mg mL-1 and 0.01 mol L−1, respectively.

TABLE 4

| | Polymer and | Sheet | | |
|---|---|---|---|---|
| | Na—Ti₃C₂Tₓ | resistance | Thickness | Conductivity |
| Sample | roughness (nm) | (Ohm sq⁻¹) | (nm) | (Scm⁻¹) |
| Na—Ti₃C₂Tₓ@PP | 59 ± 8, 88 ± 65 | 3.9 ± 0.3 | 147.0 ± 59.3 | 17442.9 |
| Na—Ti₃C₂Tₓ@HDPE | 968.0 ± 217, 661 ± 65 | 4.4 ± 0.5 | 257.2 ± 124.8 | 8836.4 |
| Na—Ti₃C₂Tₓ@UHMWPE | 181 ± 9, 244 ± 43 | 4.0 ± 0.8 | 196.0 ± 193.4 | 12755.1 |
| Na—Ti₃C₂Tₓ@PPS | 29 ± 3, 31 ± 9 | 5.1 ± 0.3 | 101.4 ± 95.3 | 19337.1 |
| Na—Ti₃C₂Tₓ@PVDF | 46 ± 2, 48 ± 3 | 3.1 ± 0.3 | 151.9 ± 108.6 | 21236.4 |
| Na—Ti₃C₂Tₓ@PTFE | 144 ± 23, 187 ± 12 | 3.6 ± 0.3 | 363.4 ± 254.1 | 7643.9 |
| Na—Ti₃C₂Tₓ@PET | 44 ± 4, 38 ± 8 | 5.2 ± 0.4 | 86.2 ± 61.7 | 22309.5 |
| Na—Ti₃C₂Tₓ@PEEK | 57.0 ± 5.0, 57 ± 2 | 3.8 ± 0.4 | 168.0 ± 49.3 | 15664.2 |
| Na—Ti₃C₂Tₓ@PP | — | 5.0 ± 1.2 | — | — |
| nonvoven | | | | |
| Na—Ti₃C₂Tₓ@PET | — | 1.9 ± 0.3 | — | — |
| fabric | | | | |
| Na—Ti₃C₂Tₓ@Kevlar | — | 2.7 ± 0.4 | — | — |
| fabric | | | | |

This suggests that the substrate chemistry does not affect the morphology and properties of the coating. Moreover, the SAA strategy is feasible for both flat and structured substrates. The assembled coatings were made on polymer fibers, curved surfaces, and 3D printed structures. For example, Na—Ti₃C₂Tr nanosheets were assembled on various polymer fibers such as those in Kevlar fabric, polypropylene nonwoven, and PET fabric. SEM images of these samples showed that the Na—Ti₃C₂Tₓ nanosheets not only wrap the surface of fibers but create bridges to connect the fibers. The assembled Na—Ti₃C₂Tₓ nanosheets on a single polymer fiber feature a wrinkled structure. For another example, assemblies of Na—Ti₃C₂Tₓ nanosheets were made on micro-patterned and 3D printed PDMS substrates. The PDMS substrates included a micropillar array or a microstrip array. The 3D printed PDMS substrate can have different 2D structural features and may be printed in letters or other patterns.

MXene assembled on high-performance polymer fibers assisted by using a salt were also obtained. Further, a large-scale (>300 cm²) Kevlar fabric was coated by Ti₃C₂Tₓ nanosheets, demonstrating the scalability of the SAA strategy.

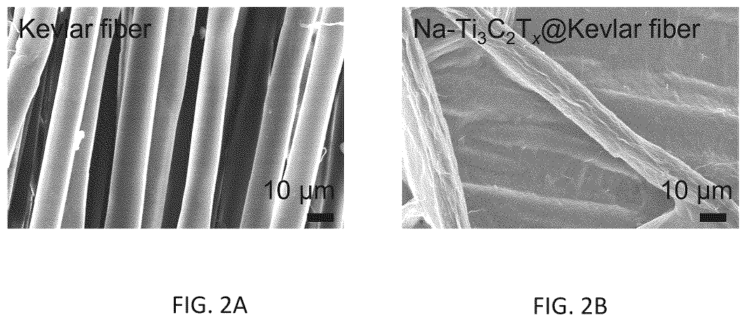

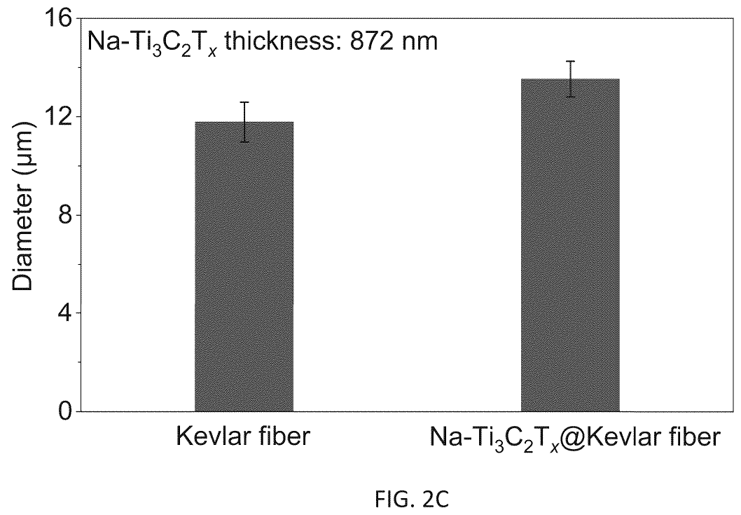

FIGS. 2A-2B show SEM images of fibers of poly-paraphenylene terephthalamide (known as Kevlar fibers) (FIG. 2A) and the fibers coated with one exemplary MXene, Ti₃C₂Tₓ, assembled assisted by NaCl as an exemplary salt (FIG. 2B) in accordance with some embodiments (bar=10 microns). FIG. 2C shows the diameters of the fibers of FIGS. 2A-2B before and after coated with Na—Ti₃C₂Tₓ. The Na—Ti₃C₂Tₓ coating had a thickness of about 872 nm. The images and the data in FIGS. 2A-2C are presented herein for demonstration only. Different coating thickness can be also obtained.

The mechanism of SAA can be understood by analyzing the evolution of interactions between MXene, the substrate, and solution upon adding salt through both experiment and molecular dynamics (MD) simulation. A significantly increased contact angles (CA) of NaCl solution (i.e., from 0.01 mol L⁻¹ to 3 mol L⁻¹) was demonstrated on Na—Ti₃C₂Tₓ thin film assembled on PDMS substrate using the SAA method. Similar trends are identified in a collection of polymer substrates.

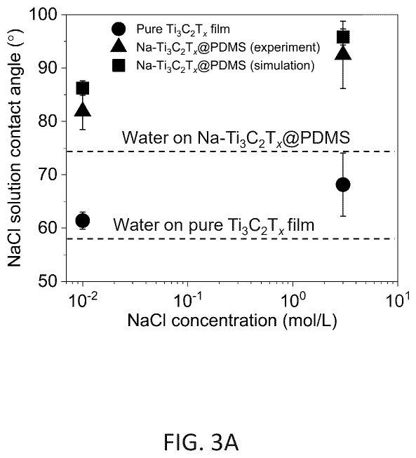

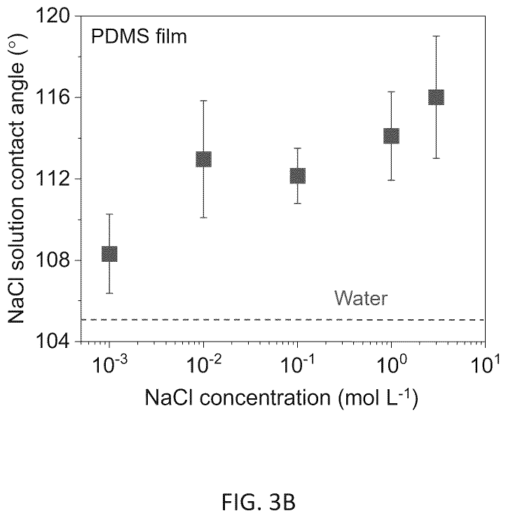

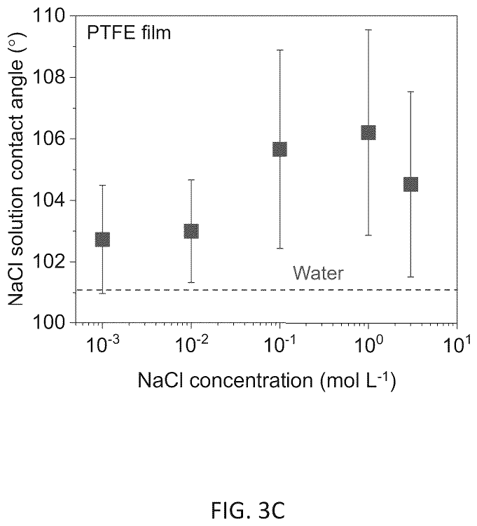

FIGS. 3A-3C show the results of contact angle measurements of pure water and NaCl solution on MXene and different polymer substrates: Pristine Ti₃C₂Tₓ film obtained by vacuum filtration and on Na—Ti₃C₂Tₓ on PDMS film obtained by SAA (FIG. 3A), Pristine PDMS film (FIG. 3B), and Pristine PTFE film (FIG. 3C). Because the concentration axes are plotted in logarithm scale, the dashed lines represent the pure water contact angles on the different substrates. Overall, with the increase of salt concentration (pure water, 0.01 mol L⁻¹ NaCl, and 3 mol L⁻¹ NaCl), a trend of increased contact angle was observed for MXene film, PDMS substrate, and PTFE substrates. As shown in FIG. 3A, the higher contact angle of Na—Ti₃C₂Tₓ compared to pristine Ti₃C₂Tr suggests two important functions of salt in the assembly process. First, NaCl in the water will increase the contact angles of water for both pristine MXene film and polymer substrate. Second, the metal ions that adhere to the surface of MXene also change the surface properties of MXene and make it more hydrophobic. Both effects lead to the energetically favorable assembly of MXene on polymer.

These results suggest that the salt solution repels both pristine MXene and polymer substrates enabling energetically favorable adhesion of MXene on polymers. It was also found the contact angle of water on Na—Ti₃C₂T, thin film (74.1°) is higher than that on pristine Ti₃C₂Tₓ thin film obtained by vacuum-assisted filtration) (57.5° suggesting salt treatment increases the hydrophobicity of MXene.

In summary, both dehydration effect of salt in the solution, and increased hydrophobicity of NaCl salt treated MXene promote the assembly of MXene. For NaCl concentration of 0.01 mol L⁻¹, the MD simulation yields a CA of 86.24+1.35°, while the experimental measurement reaches 81.89+3.42°. Upon increasing concentration to 3 mol L⁻¹, the MD-predicted CA increases to 95.81+1.51°, while the experiment yields 92.48+6.30°. The reasonably consistent results not only demonstrate the reliability of computation compared to the experiments, but also collectively suggest a transition of MXene from being hydrophilic to more hydrophobic with the addition of salt. Together with the hydrophobic nature of PDMS, the ion-driven hydrophobicity increase assists the adherence of MXene to the PDMS base and subsequent MXene coating assembly.

The SAA was further studied computationally in two consecutive steps, i.e., the MXene-PDMS assembly and the MXene-MXene assembly, which refers to further assembly of MXene onto MXene already assembled on PDMS. The presence of ions decreases the potential energy of the MXene surface, making assembly energetically more favored. After the initial layer of MXene nanosheets has formed, ions continue to enable assemblies of multilayer MXene coatings. During assembly, MXene nanosheets with adsorbed cations that neutralize the negative surface charge undergo the expulsion of water molecules and anions, while some cations remain trapped within the assembled layers.

Effects of different salt compositions were also studied. The salt ions that adhere to the surface of MXene can affect the structures and properties of the final MXene assembly. In addition, the attached metal ions may enable new or enhanced functionalities, e.g., Ag+for antibacterial function, A13+for water treatment, Sn4+for Li-ion batteries, and Pt4+for catalysis and electrocatalysis. To fully explore the potential of the SAA method, we have examined at least 49 salts with different combinations of cations and anions as described herein.

A salt may comprise a metal ion from a metal selected from Columns 1, 2, 13, 14, and 15, and transition metals in the periodic table. The salt comprises a suitable anion, for example, F, Cl⁻, Br⁻7, I, CO₃²⁻, HCO₃, NO₃²¹, and SO₄²⁻. The salts tried include the metal ions selected from Li⁺, Na⁺, K⁺, Rb⁺, Cs⁺, Mg²⁺, Ca²⁺, Sr²⁺, Ba²⁺, Al³⁺, Sc³⁰, Cr³⁺, V³⁺, Ti⁺, Mn²⁺, Fe³⁺, Co²⁺, Ni²⁺, Cu²⁺, Zn²⁺, Ga³⁺, Ge⁴⁺, Y³⁺, Zr⁴⁺, Nb⁵⁺, Mo³⁺, Ru³⁺, Re³⁺, Os³⁺, Au³⁺, Bi³⁺, Ir3⁺, Pt⁴⁺, La³⁺, Hf⁴⁺, W⁶⁺, Rh³⁺, Pd²⁺, Cd²⁺, In³⁺, Sn⁴⁺, Sb³⁺, Ag⁺, or any other suitable metal ions. These salts include a suitable anion, for example, F⁻, Cl⁻, Br, I⁻, CO₃²⁻, HCO₃⁻, NO₃⁻, and SO₄²⁻, as long as the salt is water-soluble. Good coatings of MXene on different polymer substrates were obtained.

The concentrations of the salts and Ti₃C₂Tr nanosheets in the mixed solution were kept constant at 0.01 mol L⁻¹ and 5 mg m^{L-1}, respectively. The assembly time is 15 minutes.

The detailed morphologies of some assemblies can be examined using SEM. EDS element mappings of these assemblies confirm that ions were attached to the surface of Ti₃C₂Tr nanosheets. Mostly cations of the salt were found on the surface of Ti₃C₂Tr nanosheets with a small number of anions. To prevent the interference of Cl on the surface of Ti₃C₂T, from the HF/HCl etching process, KBr was also used as the salt, and EDS from scanning transmission electron microscope suggests the coexistence of K and Br. According to Fourier transform infrared spectroscopy (FTIR) analysis, the —OH group's peak intensity at 3432 cm⁻¹ decreased after salt addition, indicating the weaker hydrophilicity of Ti₃C₂Tₓ nanosheets. The same evidence can also be found in X-ray photoelectron spectra (XPS) of pristine Ti₃C₂Tₓ and Cs—Ti₃C₂Tₓ.

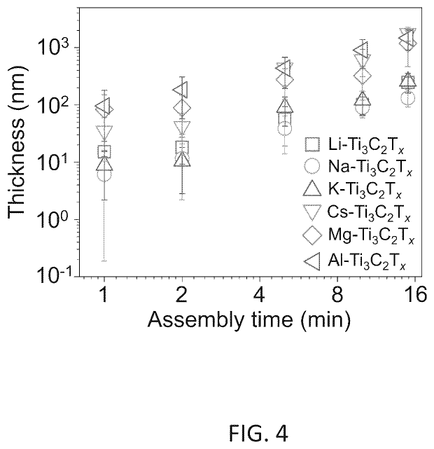

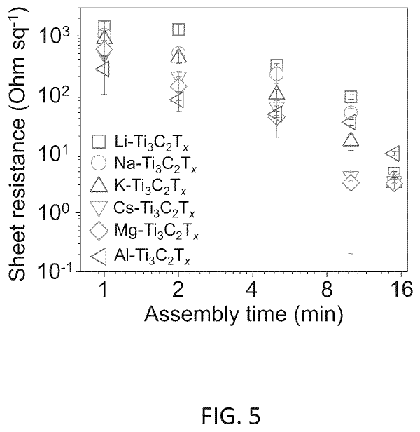

Salt species actively affect the assembly kinetics. For example, by fixing the anion (i.e., Cl—) and changing the cations (i.e., Lit, Na⁺, K⁺, Cs⁺, Mg²⁺, and Al³⁺), experiments were conducted to study the thickness and sheet resistance evolution of Ti₃C₂Tₓ coatings on PDMS substrate with respect to assembly time and some exemplary salt species. The results are shown in FIGS. 4-5.

While similar trends of increased thickness and decreased sheet resistance with respect to assembly time were observed for all salts, under the same conditions, Cs—Ti₃C₂Tₓ coating was 10 times thicker than Na—Ti₃C₂Tₓ. The deposition speed can be tailored by the type of cations used, following the sequence of Cs⁺>Al³⁺>Mg²⁺>K+>Li⁺>Na⁺. This trend can be attributed to different dehydration capabilities of cations upon confinement in Ti₃C₂Tₓ nanosheets, as well as the charge of the ion. Cosmotropic Al³⁺ and Mg²⁺ produce stronger electrostatic attraction when intercalated between MXene nanosheets. It should be noted that though ions with higher dehydration capabilities, such as chaotropic Cs⁺ and K⁺, facilitate the MXene aggregation and lead to higher assembly speed, they result in increased coating roughness. Moreover, the addition of salt changes the spacing among MXene nanosheets. For example, by fixing the anion (i.e., Cl—) and changing the cations (i.e., Lit, Na⁺), the spacing of stacked Ti₃C₂Tr nanosheets changes from 14.1 (with Li⁺) to 13.2 Å (with Na⁺), which can be used for tunable piezoresistive sensors as previous studies have shown. The Raman peak positions remain almost unchanged, independent of the ion used, indicative of no detectable chemical changes in Ti₃C₂Tₓ coatings with metal ions compared to the pristine ones.

Thermal management using MXene-coated polymers, especially high-performance polymers such as PEEK and Kevlar, was further studied.

To enable thermal management at high and low temperatures, Na—Ti₃C₂Tₓ nanosheets were assembled on two of the most temperature-resistant polymers: PEEK film (Na—Ti₃C₂Tₓ on PEEK, coating thickness: ˜ 170 nm) and Kevlar fabric (Na—Ti₃C₂Tₓ on Kevlar, coating thickness: ˜ 870 nm). The SEM images and the thickness of the Kevlar fibers are illustrated in FIGS. 2A-2C.

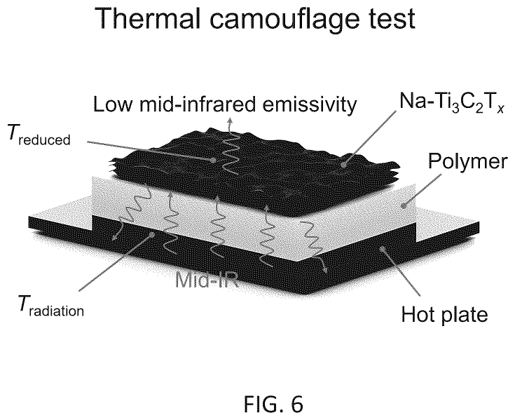

The thermal management mechanism is shown in FIG. 6, which is a schematic illustration of thermal camouflage process using Na—Ti₃C₂Tr coatings on high-performance polymers.

When a MXene coating is applied to the polymer sample placed on a hot plate, the low-emissivity MXene leads to the measured by the IR camera temperature (T_{reduced}) on the surface being much lower than the hot plate temperature (T_{radiation}).

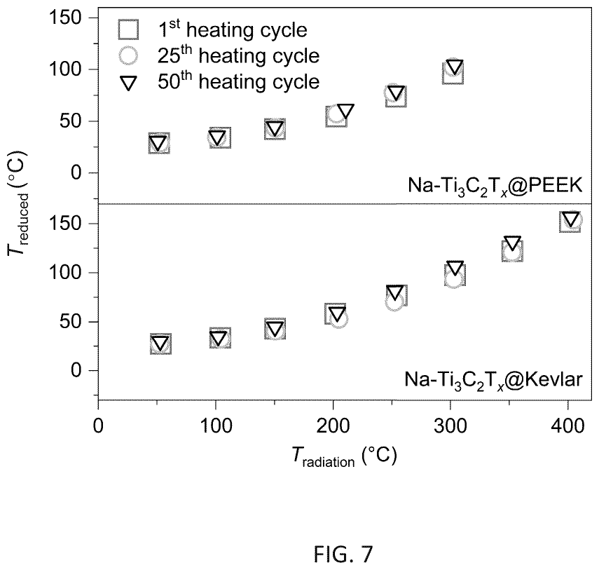

FIG. 7 shows reduction temperature (T_{reduced}) for Na—Ti₃C₂Tₓ on PEEK and Na—

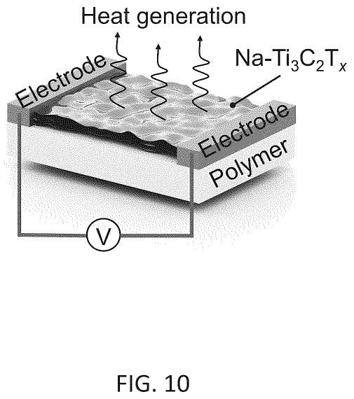

Ti₃C₂T on Kevlar fabrics within 50 heating cycles. FIG. 10 shows evolutions of reduction temperature (T_{reducted}) for Na—Ti₃C₂Tₓ on PEEK and Na—Ti₃C₂Tr on Kevlar during 48 hours at radiation temperatures (T_{radiation}) of 300° C. and 400° C., respectively.

When the hot plate was heated up to 300° C. for Na—Ti₃C₂T, on PEEK and 400° C. for Na—Ti₃C₂Tₓ on Kevlar, the temperature difference (T_{radiation}-T_{reduced}) reached about 200° C. for Na—Ti₃C₂Tr@PEEK and about 250° C. for Na—Ti₃C₂Tr@Kevlar. In comparison, the T_{radiation}-T_{reduced} of pure PEEK and Kevlar was only 14° C. and 58° C., respectively.

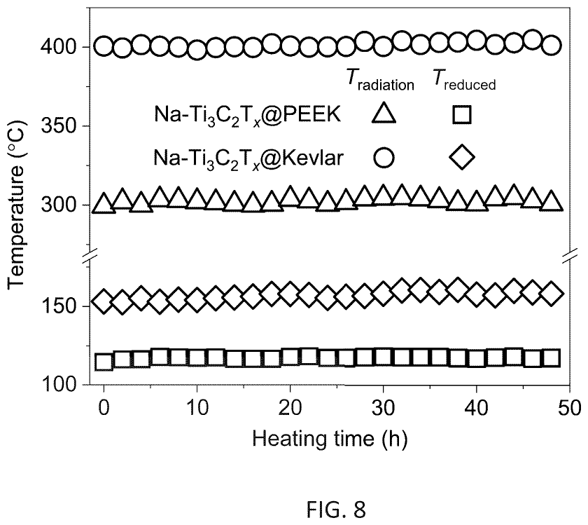

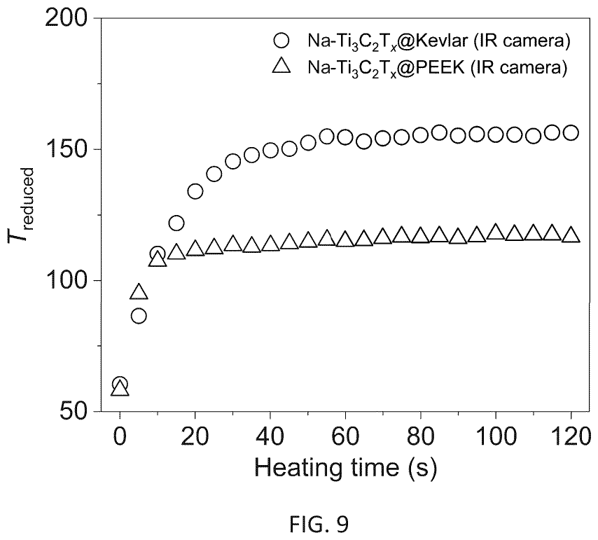

The stability of the thermal camouflage properties was examined over 50 heating and cooling cycles and in a long-term heating test for 48 hours, as shown in FIGS. 7-8. FIG. 9 shows reduction temperature (T_{reduced}) evolution of Na—Ti₃C₂Tₓ on PEEK at 300° C. and Na—Ti₃C₂Tₓ on Kevlar at 400° C. for 120 s. Table 5 shows the results of emissivity/absorbance of Na—Ti₃C₂Tₓ on PEEK, and Na—Ti₃C₂Tₓ on Kevlar during heating/cooling cycles, compared to the polymers without the coating.

TABLE 5

| | | Emissivity/ | Emissivity/ | Emissivity/ |
|---|---|---|---|---|
| | | absorbance | absorbance | absorbance |
| Sample | Condition | (1^{st} cycle) | (25^{th} cycle) | (50^{th} cycle) |
| Na—Ti₃C₂Tₓ on PEEK | Heating 100° C. | 0.10 | 0.10 | 0.14 |
| | Heating 200° C. | 0.16 | 0.17 | 0.19 |
| | Heating 300° C. | 0.18 | 0.21 | 0.22 |
| | Cooling 200° C. | 0.16 | 0.17 | 0.20 |
| | Cooling 100° C. | 0.10 | 0.11 | 0.14 |
| Na—Ti₃C₂Tₓ on Kevlar | Heating 100° C. | 0.38 | 0.36 | 0.37 |
| | Heating 200° C. | 0.47 | 0.46 | 0.41 |
| | Heating 300° C. | 0.48 | 0.44 | 0.44 |
| | Heating 400° C. | 0.50 | 0.48 | 0.45 |
| | Cooling 300° C. | 0.49 | 0.50 | 0.44 |
| | Cooling 200° C. | 0.46 | 0.47 | 0.44 |
| | Cooling 100° C. | 0.43 | 0.44 | 0.38 |
| PEEK | Heating 100° C. | 0.87 | — | — |
| | Heating 200° C. | 0.95 | — | — |
| | Heating 300° C. | 1.01 | — | — |
| | Cooling 200° C. | 0.87 | — | — |
| | Cooling 100° C. | 0.90 | — | — |
| Kevlar fabric | Heating 100° C. | 0.94 | — | — |
| | Heating 200° C. | 1.10 | — | — |
| | Heating 300° C. | 1.02 | — | — |
| | Heating 400° C. | 0.93 | — | — |
| | Cooling 300° C. | 0.99 | — | — |
| | Cooling 200° C. | 0.96 | — | — |
| | Cooling 100° C. | 0.92 | — | — |

As shown in FIGS. 7-9 and Table 5, the overlapping data at the 1st, 25th, and 50th cycles of both sets of samples demonstrate excellent thermal stability and repeatability of MXene coated PEEK film or Kevlar fabric. After holding the sample at the highest T_{radiation} for 48 hours, T_{reduced} reaches 117.2° C. for Na—Ti₃C₂Tₓ on PEEK and 158° C. for Na—Ti₃C₂Tₓ on Kevlar with only a small increase of 2.8° C. and 4.9° C. only compared to their initial values, respectively. While the thermal camouflage capability can be mainly attributed to the Na—Ti₃C₂Tr coating, the outstanding cyclic and long-term thermal camouflage stability is a result of the stable polymer substrate and the stable interface between the MXene and the polymer.

FIG. 9 shows reduction temperature (T_{reduced}) evolution of Na—Ti₃C₂Tₓ on PEEK at 300° C. and Na—Ti₃C₂Tr on Kevlar at 400° C. for 120 s. Through this T_{reduced} evolution determination at the initial stage, it was concluded that after the first 120 seconds, the T_{reduced} will stabilize without increasing or decreasing. Thus, for the long-term thermal camouflage performance, the data after 120 seconds were recorded.

The highest T_{radiation} means the highest temperature of the environment such as the hot plate for testing the samples for thermal camouflage. It is related to the thermal-resistant capability of polymer substrates coated with the nanomaterials. For example, the PEEK substrates can be tested at a temperature up to 300° C. The Kevlar substrates can be tested at a temperature up to 400° C.

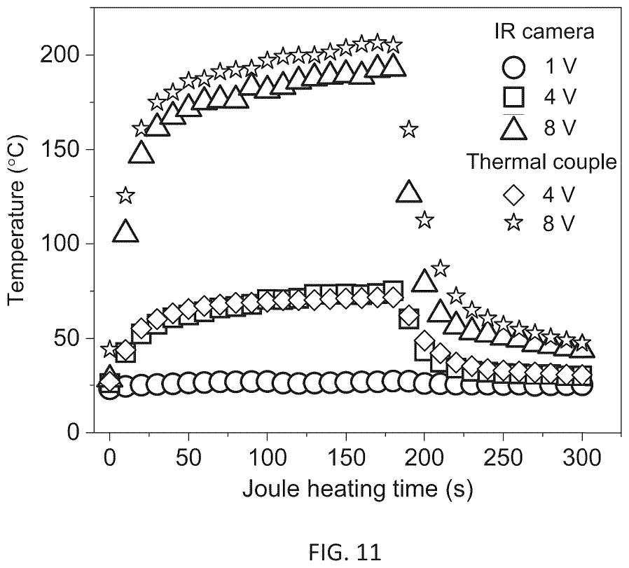

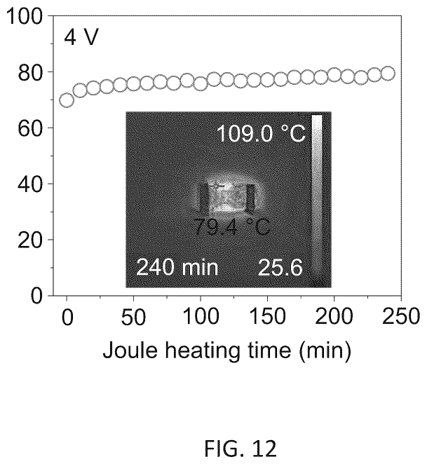

The Joule heating performance of Na—Ti₃C₂Tr on Kevlar and PEEK was further studied, as shown in FIGS. 10-12. FIG. 10 schematically illustrates of Joule heating using Ti₃C₂Tₓ coating on a high-performance polymer. FIG. 11 shows voltage-dependent Joule heating performance of Na—Ti₃C₂Tₓ on Kevlar. FIG. 12 shows long-term Joule heating performance of Na—Ti₃C₂Tr on Kevlar under 4 V.

Referring to FIG. 10, Ti₃C₂Tₓ coating is assembled on a substrate, for example, a polymer substrate comprising a high-performance polymer such as PEEK and Kevlar. Two electrodes are electrically connected with the coating layer and are used to apply a voltage.

By regulating the applied voltages, different heating temperatures (75.2° C. at 4 V and 192.9° C. at 8 V by IR camera) were rapidly achieved, where the Treal measured by thermocouple showed similar values (71.7° C. at 4 V and 206.3° C. at 8 V) (FIG. 11). Then, a long-term Joule heating test was performed at 4 V for 4 hours (FIG. 12), showing excellent stability. The stable performance can be attributed to the robustness of Na—Ti₃C₂Tr on Kevlar (or PEEK) as confirmed by using SEM and Raman characterization of the samples after heated compared to the original samples. After 50 heating cycles and 48-hour heating, the samples were nearly the same as the original samples. The Raman peak of Na—Ti₃C₂T, retain the positions, and while there is a very small decrease in intensity, indicative of minimal structure damage.

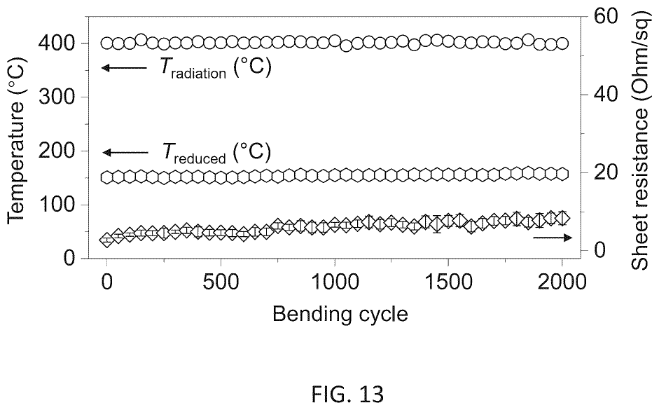

One of the objectives in the present disclosure is to use the nanomaterial coating disposed on a substate as described herein as wearable/flexible products. In wearable/flexible applications, both the flexibility and washing stability of MXene-coated polymer films and textiles are essential. The bending durability of Na—Ti₃C₂Tₓ on Kevlar was tested by comparing thermal camouflage performance and sheet resistance evolution before and after 2000 bending cycles. FIG. 13 shows the results of the reduction temperature at a radiation temperature T_{radiation} of 400° C. and sheet resistance of Na—Ti₃C₂Tr on Kevlar during 2,000 bending cycles. Both T_{reduced}(from 151.0° C. to 157.3° C. at T_{radiation}=400° C.) and sheet resistance (from 2.7 Ohm sq-1 to 8.3 Ohm sq⁻¹ at room temperature) showed a minimal change.

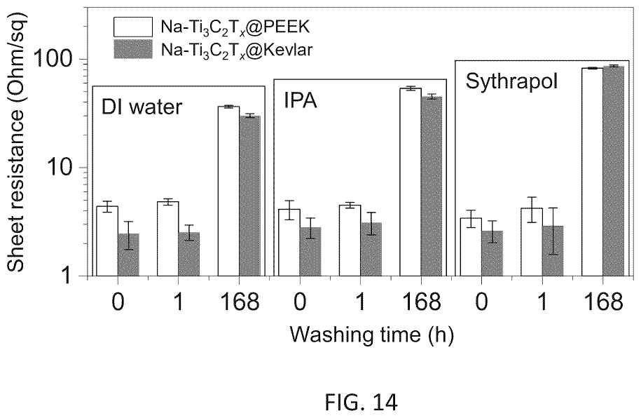

The washing stability was also performed through a stirring washing test, in which a solution was stirred using a magnetic stir bar at 1,000 rpm in a 1L beaker to mimic the real washing condition. Three types of solution were tested: DI water, IPA solution, and an industrial strength washing agent under trademark SYNTHRAPOL® (10%, v/v). The sheet resistances of Na—Ti₃C₂T, on PEEK and Na—Ti₃C₂Tr on Kevlar before and after washing were compared (FIG. 14).

After 168 hours of continuous washing in the harshest SYNTHRAPOL® solution, sheet resistance increased from 3.4 Ohm sq-1 to 82 Ohm sq⁻¹ for Na—Ti₃C₂Tₓ on PEEK and 2.6 Ohm sq-1 to 86.5 Ohm sq⁻¹ for Na—Ti₃C₂Tr on Kevlar. Considering a washing frequency of once a week for 1 hour, such wearables made of these coated films or fabrics can last for at least 3 years. The strong interface between Na—Ti₃C₂Tr nanosheets and the polymer substrates, which was examined under SEM, can explain this excellent performance. After bended for 2,000 cycles or washed in water, IPA, or the SYNTHRAPOL® solution for seven days, the morphology of the coatings was retained.

The Na—Ti₃C₂Tr on Kevlar can withstand temperature up to 400° C., can decrease temperature by 100-200° C., and has excellent Joule heating capability up to 200° C. The Na—Ti₃C₂Tₓ on Kevlar also has excellent washing durability and bending durability.

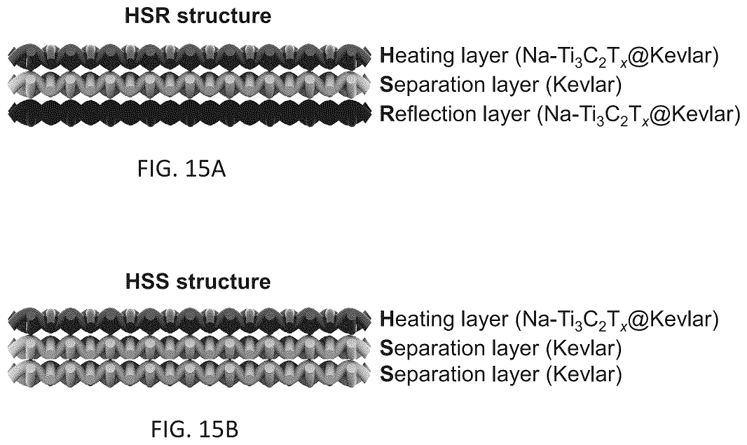

FIGS. 15A-15B illustrate two exemplary structures for an article such as a protective garment or gear in accordance with some embodiments. FIG. 15A is a sectional view illustrating an exemplary product comprising a tri-layer H-S-R structure comprising: a Heating layer (Na—Ti₃C₂Tₓ on Kevlar), a Separation layer (pure Kevlar), and a Reflection layer (Na—Ti₃C₂Tr on Kevlar). The heating layer and the reflection layer may be the same. The separation layer is disposed between the coated layers. FIG. 15B is a sectional view illustrating an exemplary product comprising a tri-layer H—S—S structure comprising: a Heating layer (Na—Ti₃C₂Tₓ on Kevlar) and two Separation layers (Kevlar). The reflection layer in FIG. 15A is replaced with another separation layer made of the polymer only.

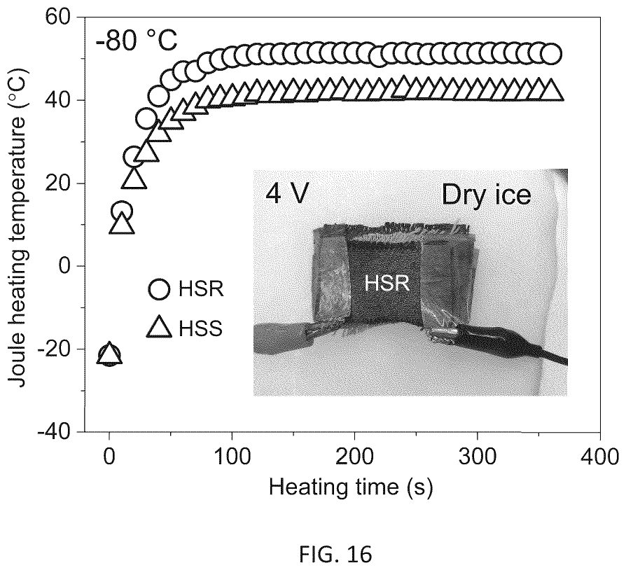

FIG. 16 shows the Joule heating temperatures of the H—S—R protection gear in contact with dry ice (−78.5° C.). For comparison, the reference sample is H—S—S in which the reflection layer is substituted by a separation layer. The H—S—R protection gear structure provides much better Joule heating than the H—S—S structure.

The combination of outstanding mid-IR reflectivity, low thermal conductivity, Joule heating capability, and bending and washing stability of MXene-coated high-performance polymers can be used in protection gear or garment for individuals and equipment operating under extreme-temperature environments. The performance range of the Na—Ti₃C₂Tₓ on Kevlar system is much better than any existing materials. The Na—Ti₃C₂Tₓ on Kevlar provides the highest T_{radiation}, the highest temperature difference in thermal camouflage, the highest Joule heating temperature, excellent bending durability, and washing durability.

To demonstrate the potential applications, a three-layer heat-management gear is designed to be used, for example, in Mars exploration to overcome the ultralow temperature (mean temperature:−65° C.). As shown in FIG. 15A, a Na—Ti₃C₂Tr/Kevlar layer was connected to an external power source and used as the heating layer (H-layer), an insulating Kevlar layer was used as a separator (S-layer) to prevent the short circuit, and another Na—Ti₃C₂Tr/Kevlar layer was used to reflect mid-IR from the heating layer (R-layer) and prevent radiative loss to the dry ice (about−80° C.) environment (FIG. 16). Such gear can be called H—S—R gear. An IR camera was used to monitor the temperature of the H-layer. With a 4 V bias, the H-layer reached 51.1° C. For comparison, if the R-layer is substituted with an S-layer to form an H—S—S gear, the H-layer can only reach 41.7° C. This ˜10° C. difference is significant considering that the Na—Ti₃C₂Tₓ layer on the R-layer is only 872-nanometer-thick.

In some application, it is not necessary to build H—S—R gear all over the body of a user. As hands and feet are the most vulnerable body parts at low temperatures, the H—S—R gear structure can be built into mittens and boots to energy consumption. The design can be optimized to provide even better performance. For example, other MXenes with higher emissivity can be used for the heating layer and a smooth Ti₃C₂Tr coating on a polymer film can be used for the reflective layer.

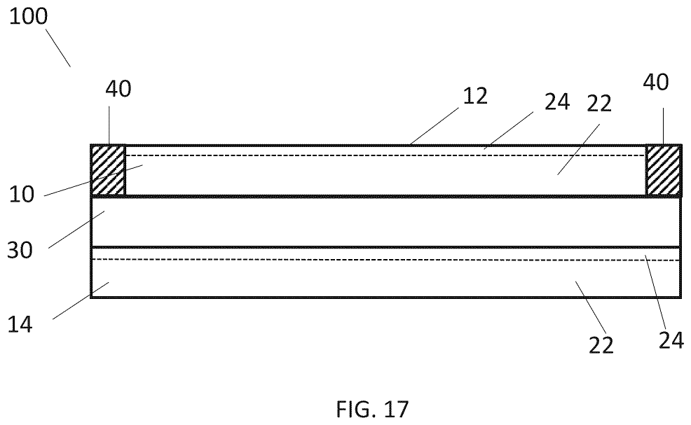

Referring to FIG. 17, the present disclosure provides an article comprising an exemplary structure for an article such as a protective gear or garment in accordance with some embodiments. This structure is based on the H—S—R structure as shown in FIG. 15A.

In accordance with some embodiments, an exemplary article 100 comprises at least one coated layer 10. In some embodiments, the at least one coated layer 10 in the article 100 comprises a first coated layer 12 as a heating layer and a second coated layer 14 as a reflective layer. The second coated layer 14 is the same as the first coated layer 12 in some embodiments. The reflective layer may be also replaced by a different layer comprising different chemical and physical structures. The article 100 further comprises a separation layer 30 disposed between the first coated layer 12 and the second coated layer 14. The separation layer 30 is disposed above the reflective layer, which is the second coated layer 14. The first coated layer 12 is disposed above the separation layer 30.

Each coated layer 10 such as the first coated layer 12 or the second coated layer 14 comprises a substrate 22 and a coating 24 disposed on the substrate 22. The substrate 22 may be a polymer film or fabrics comprising fibers. The coating 24 and the substrate may not be fully separate layers. Therefore, a dotted lines are used for illustration only in FIG. 17. As described herein, the coating 24 comprises a layered nanomaterial and a solute embedded and uniformly distributed in the layered nanomaterial. The solute comprises at least one salt soluble in a solvent, and the substrate comprises a polymer.

In some embodiments, the article 100 further comprises at least two electrodes 40 connected with the coating 24 in the coated layer 10. The electrodes 40 may be connected with an electricity source. The electrodes 40 and the coating 24 are configured to provide Joule heating.

In some embodiments, the article 100 is configured to be wearable and protective and may provide thermal management functions. For example, the article 100 is a protective gear or garment. In some embodiments, the polymer in the substrate 22 is a high-performance polymer such as PEEK or poly(para-phenylene terephthalamide). In some embodiments, the substrate 22 comprises fibers or fabrics, which may be made of a high-performance polymer such as PEEK and poly(para-phenylene terephthalamide).

A universal salt-assisted assembly process has been developed for fast large-scale assembly of MXene coatings on polymer substrates. The addition of a salt or salts such as NaCl to the MXene colloidal solution in water increases the hydrophobicity of both MXene and the polymer, and promotes MXene deposition, which was substrate-independent. Furthermore, the assembly kinetics, overall coating thickness, and architecture can be tailored by altering the salt ions and concentration. Coating of high-performance polymers, such as Kevlar and PEEK, with MXenes holds the potential for significant advancements in thermal management under extremely low and high temperatures, preventing heat loss, and protecting equipment and personnel. There are numerous applications for polymers coated by conductive MXene films with a variety of optical and electronic properties. The incorporation of catalytic metals like platinum or bactericidal silver ions further expands the range of potential applications of these materials.

In another aspect, the present disclosure provides a method of making the article as described herein. The assembly of the nanomaterial may be assisted in an acoustic field under sonication, or a shear field induced by dip coating, and a shear field induced by mechanical stirring. For example, the nanomaterial may be dispersed, pre-treated, and/or exfoliated after sonication is applied. The substrate is contacted with the mixture through an acoustic agitated process, a dip-coating process, a roll-to-roll process, a mechanical stirring process, or a combination thereof. For example, a dip coating process or a roll-to-roll process is used in some embodiments.

In some embodiments, such a method comprises making the at least one coated layer through a solute-assisted assembly method as described herein. The solute-assisted assembly method comprises steps of providing a mixture comprising the solvent, the solute comprising at least one salt, and the layered nanomaterial, applying sonication to the mixture, and contacting the substrate with the mixture. In some embodiments, the layered nanomaterial comprises MXene. In some embodiments, the solvent is water or comprises water and another solvent. The mixture contains no surfactant. The substrate comprises a polymer.

In another aspect, the present disclosure provides a method of using the article as described herein. Such a method comprises providing at least one thermal management function through the at least one coated layer. In some embodiments, the article is a protective garment or gear, and the at least one thermal management function comprises thermal camouflage, Joule heating, or both.

Although the subject matter has been described in terms of exemplary embodiments, it is not limited thereto. Rather, the appended claims should be construed broadly, to include other variants and embodiments, which may be made by those skilled in the art.

What is claimed is:

1. An article, comprising at least one coated layer, the at least one coated layer comprising:
a substrate and a coating disposed on the substrate, the coating comprising a layered nanomaterial and a solute embedded and distributed in the layered nanomaterial,
wherein the solute comprises at least one salt soluble in a solvent, and the substrate comprises a polymer.

2. The article of claim 1, wherein the layered nanomaterial has a thickness in a range of from about 1 nm to about 1,000 nm.

3. The article of claim 1, wherein the layered nanomaterial comprises nanosheets of MXene, wherein MXene is a layered nitride, carbide, or carbonitrides of at least one transition metal (M) having a formula of Mₙ₊₁XₙTₓ, wherein X is nitrogen or carbon, n is an integer representing a number of layers of nitrogen or carbon, n+1 is a number of layers of the at least one transition metal, T is a functional group, and x is in a range of from 0 to 2.

4. The article of claim 3, wherein n is in the range of from 1 to 3.

5. The article of claim 3, wherein the MXene has a formula of Ti₃C₂Tₓ.

6. The article of claim 5, wherein T is selected from the group consisting of F, Cl, O, OH, and a combination thereof.

7. The article of claim 1, wherein the layered nanomaterial is oriented in a plane substantially parallel to a surface of the substrate.

8. The article of claim 1, wherein the layered nanomaterial is hydrophilic while the substrate is hydrophobic.

9. The article of claim 1, wherein the polymer in the substrate is in a form of a film, or a fabric comprising fibers.

10. The article of claim 1, wherein the polymer is selected from the group consisting of polyether ether ketone (PEEK), polyvinylidene fluoride (PVDF), polytetrafluoroethylene (PTFE), polyethene (PE), polypropylene (PP), polyethylene terephthalate (PET), polybenzimidazole (PBI), polycarbonate (PC), polyether sulfone (PES), polyoxymethylene (POM), polyethylenimine (PEI), acrylonitrile butadiene styrene (ABS), poly(phthalaldehyde) (PPA), polyurethane (PU), a polyamide, and any combination thereof.

11. The article of claim 1, wherein the polymer is PEEK or poly(para-phenylene terephthalamide).

12. The article of claim 1, wherein the at least one salt comprises a metal cation and an anion.

13. The article of claim 12, wherein the metal ion is selected from the group consisting of Li⁺, Na⁺, K⁺, Rb⁺, Cs⁺, Mg²⁺, Ca²⁺, Sr²⁺, Ba²⁺, Al³⁺, Sc³⁰, Cr³⁺, V³⁺, Ti⁴⁺, Mn²⁺, Fe³⁺, Co²⁺, Ni²⁺, Cu²⁺, Zn²⁺, Ga³⁺, Ge⁴⁺, Y³⁺, Zr⁴⁺, Nb⁵⁺, Mo³⁺, Ru³⁺, Re³⁺, Os³⁺, Au³⁺, Bi³⁺, Ir³⁺, Pt⁴⁺, La³⁺, Hf⁴⁺, W⁶⁺, Rh³⁺, Pd²⁺, Cd²⁺, In³⁺, Sn⁴⁺, Sb³⁺, Ag⁺, and a combination thereof, the anion is selected from the group consisting of F⁻, Cl⁻, Br⁻, I⁻, CO₃²⁻, HCO₃⁻, NO₃⁻, SO₄²⁻, or a combination thereof, and the at least one salt is water-soluble.

14. The article of claim 1, wherein the coating is electrically and thermally conductive, and the article is configured to be used for thermal management.

15. The article of claim 1, further comprising at least two electrodes connected with the coating and configured to provide Joule heating.

16. The article of claim 1, wherein the at least one coated layer comprises a first coated layer and a second coated layer the same as the first coated layer.

17. The article of claim 1, further comprising a separation layer disposed between the first coated layer and the second coated layer.

18. The article of claim 1, wherein the article is configured to be wearable and protective.

19. The article of claim 1, wherein the article is a protective garment or gear.

20. A method of making the article of claim 1, comprising making the at least one coated layer through a solute-assisted assembly method.

21. The method of claim 20, wherein the solute-assisted assembly method comprises:
providing a mixture comprising the solvent, the solute comprising at least one salt, and the layered nanomaterial;
applying sonication to the mixture; and
contacting the substrate with the mixture.

22. The method of claim 20, wherein the layered nanomaterial comprises MXene, and the solvent is water or contains water.

23. A method of using the article of claim 1, comprising providing at least one thermal management function through the at least one coated layer.

24. The method of claim 23, wherein the article is a protective garment or gear, and the at least one thermal management function comprises thermal camouflage, Joule heating, or both.
